(19) United States
(12) Patent Application Publication
(10) Pub. No.: US 2013/0084235 A1
(43) Pub. Date: Apr. 4, 2013

(54) CARBON NANOTUBE DEVICE, PROCESS FOR PRODUCTION OF CARBON NANOTUBE, AND DEVICE FOR PRODUCTION OF CARBON NANOTUBE

(71) Applicant: Yosuke Koike, Sagamihara-shi (JP)

(72) Inventor: Yosuke Koike, Sagamihara-shi (JP)

(73) Assignee: Aisin Seiki Kabushiki Kaisha, Kariya-shi (JP)

(21) Appl. No.: 13/703,263

(22) PCT Filed: Jul. 28, 2011
(86) PCT No.: PCT/JP2011/067824

§ 371 Date: Dec. 10, 2012

(30) Foreign Application Priority Data
Aug. 4, 2010 (JP) 2010-175434
Aug. 4, 2010 (JP) 2010-175448

(51) Int. Cl. C01B 31/02

(52) U.S. Cl. CPC C01B 31/0226
USPC 423/447.3; 422/310; 422/198

(57) ABSTRACT

A new carbon nanotube device is provided. The carbon nanotube device has first carbon nanotubes and second carbon nanotubes that are different from each other in property. The carbon nanotube device includes: an object having a first carbon nanotube forming surface and a second carbon nanotube forming surface; first carbon nanotubes formed on the first carbon nanotube forming surface; and second carbon nanotubes formed on the second carbon nanotube forming surface, the second carbon nanotubes being different from the first carbon nanotubes in property.

### TECHNICAL FIELD

This invention relates to a carbon nanotube device, a method of manufacturing carbon nanotubes and carbon nanotube manufacturing apparatus.

### BACKGROUND ART

Patent Document 1 discloses a capacitor in which carbon nanotubes are respectively formed on an upper surface and a lower surface of a substrate that are reversely opposed to each other. According to this capacitor, the length of the carbon nanotubes formed on the upper surface of the substrate is equalized to the length of the carbon nanotubes formed on the lower surface of the substrate.

Patent Document 2 discloses carbon nanotube manufacturing apparatus that includes: an installation portion for setting a substrate in a reaction chamber; and a single pipe-shaped gas feeding pipe that faces the substrate set at the installation portion with a clearance interposed at an upper position. In this apparatus, the gas feeding pipe is wound. A circumferential wall of the gas feeding pipe is provided with a plurality of outlets. According to the disclosure, when a reaction gas is let out from the outlets of the gas feeding pipe onto the substrate, the distance between the outlets and the carbon nanotube forming surface of the substrate is set at 100 millimeters or less.

Patent Document 3 discloses carbon nanotube manufacturing apparatus that: feeds a reaction gas substantially in parallel to an upper surface and a lower surface of a flat substrate installed in a reaction chamber; and forms the carbon nanotubes on the upper surface and the lower surface of the substrate.

Patent Document 1: Japanese Unexamined Patent Application Publication No. 2007-48907

Patent Document 2: Japanese Unexamined Patent Application Publication No. 2008-137831

Patent Document 3: Japanese Unexamined Patent Application Publication No. 2004-332093

### SUMMARY OF INVENTION

Technical Problem

According to Patent Document 1, the substrate is provided with the first carbon nanotubes and the second carton nanotubes such that the first and second carbon nanotubes reversely extend in opposite directions. The first carbon nanotubes and the second carbon nanotubes are basically the same in terms of the characteristics such as length.

Completed in view of the circumstances described above, this invention serves to provide a new carbon nanotube device including first carbon nanotubes and second carbon nanotubes having different characteristics, which is advantageous in making device characteristics hybrid. In addition, this invention serves to provide a new carbon nanotube manufacturing method and carbon nanotube manufacturing apparatus capable of, as long as carbon nanotubes are formed on the same carbon nanotube forming surface in a target object, reducing irregularities of the carbon nanotubes formed on the same carbon nanotube forming surface in the target object.

Solution To Problem

A carbon nanotube device according to a first aspect of the invention includes a carbon nanotube element, the carbon nanotube element including an object having a first carbon nanotube forming surface and a second carbon nanotube forming surface, first carbon nanotubes formed on the first carbon nanotube forming surface of the object, and second carbon nanotubes formed on the second carbon nanotube forming surface of the object, the second carbon nanotubes being different from the first carbon nanotubes in property.

The “property” above means physical properties and/or chemical properties. The property are properties in respect of the carbon nanotubes (CNT) that may be at least one of a length, a diameter, a tube number, a layer number, crystallinity, an amount of lost portions, a type of functional groups, an amount of functional groups, a density, a weight, a distribution and the like. The carbon nanotube device according to the aspect of the invention exerts both of a performance provided by the first carbon nanotubes and a performance provided by the second carbon nanotubes. Thus, the device according to the aspect of the invention is advantageous in making device characteristics hybrid. The carbon nanotube device according to the aspect of the invention is applicable to energy devices such as electric double layer capacitors, lithium ion capacitors, fuel cells, lithium batteries and solar cells.

(2) A method of manufacturing carbon nanotubes according to a second aspect of the invention includes: (i) preparing process that includes: (ia) preparing a target object having a carbon nanotube forming surface on which the carbon nanotubes are formed; (ib) preparing a gas path forming member that includes: a reaction chamber adapted to accommodate the target object; a gas feeding chamber that faces the carbon nanotube forming surface of the target object accommodated in the reaction chamber with a clearance interposed, the gas feeding chamber extending in a planar direction in which the carbon nanotube forming surface extends; and a plural ity of outlets communicating with the gas feeding chamber and the reaction chamber and adapted to let out a reaction gas in the gas feeding chamber into the reaction chamber; and (ic) preparing a heat source adapted to heat to a carbon nanotube forming temperature at least one of the carbon nanotube forming surface of the target object, the gas path forming member and the reaction gas; and (ii) carbon nanotube forming process that includes: while at least one of the carbon nanotube forming surface of the target object, the gas path forming member and the reaction gas is heated to the carbon nanotube forming temperature, feeding the reaction gas into the gas feeding chamber and letting out the reaction gas in the gas feeding chamber through the outlets onto the carbon nanotube forming surface of the target object, such that the carbon nanotubes are formed on the carbon nanotube forming surface of the target object, the reaction gas being let out in a direction that intersects with the planar direction in which the carbon nanotube forming surface of the target object within the reaction chamber extends.

The gas feeding chamber faces the carbon nanotube forming surface of the target object accommodated in the reaction chamber with a clearance interposed, and extends in the planar direction in which the carbon nanotube forming surface extends. The plurality of outlets communicates with the gas feeding chamber and the reaction chamber, and lets out the reaction gas in the gas feeding chamber onto the target object in the reaction chamber. With this arrangement, a shortest distance L between each outlet to the carbon nanotube forming surface of the target object when the reaction gas is let out is uniformed as much as possible. Accordingly, within the same carbon nanotube forming surface of the target object, the irregularities in the characteristics of the carbon nanotubes formed on each portion of the carbon nanotube forming surface are reduced.

(3) Carbon nanotube manufacturing apparatus according to a third aspect of the invention is adapted to manufacture carbon nanotubes on a target object that has a carbon nanotube forming surface on which the carbon nanotubes are formed. The apparatus includes: (i) a base body; (ii) a gas path forming member including: a reaction chamber adapted to accommodate the target object, a facing wall provided to the base body and adapted to face the carbon nanotube forming surface of the target object with a clearance interposed, the facing wall extending in a planar direction in which the carbon nanotube forming surface of the target object extends; a plurality of outlets formed in the facing wall to penetrate through the facing wall; a gas feeding chamber defined by the facing wall and extending in the planar direction in which the carbon nanotube forming surface of the target object extends, the gas feeding chamber being in communication with the outlets; and a gas outlet path in communication with the reaction chamber; and (iii) a heat source provided to the base body and adapted to heat to a carbon nanotube forming temperature at least one of the carbon nanotube forming surface of the target object, the gas path forming member and the reaction gas.

The gas feeding chamber faces the carbon nanotube forming surface of the target object accommodated in the reaction chamber with the clearance interposed, and extends in the planar direction in which the carbon nanotube forming surface extends. The plurality of outlets communicates with the gas feeding chamber and the reaction chamber, and lets out the reaction gas in the gas feeding chamber onto the target object in the reaction chamber. With this arrangement, a shortest distance L between each outlet and the carbon nanotube forming surface of the target object when the reaction gas is let out is uniformed as much as possible. With this arrangement, within the same carbon nanotube forming surface, the irregularities in the growth of the carbon nanotubes formed on the same carbon nanotube forming surface are reduced.

Advantageous Effects of Invention

The carbon nanotube device according to the aspect of the invention includes the first carbon nanotubes and the second carbon nanotubes that are different from each other in property (i.e., the property is at least one of length, diameter, tube number per unit area, number of layers, crystallinity, lost portion amount, functional group type, functional group amount, density, weight, distribution and others), and thus is advantageous in making the device characteristics hybrid.

In the carbon nanotube manufacturing method and the carbon nanotube manufacturing apparatus according to the aspects of the invention, the gas feeding chamber faces the carbon nanotube forming surface of the target object accommodated in the reaction chamber with the clearance interposed, and extends in the planar direction in which the carbon nanotube forming surface extends. The plurality of outlets communicates with the gas feeding chamber and the reaction chamber, and lets out the reaction gas in the gas feeding chamber onto the target object in the reaction chamber. With this arrangement, a shortest distance L between each outlet and the carbon nanotube forming surface of the target object when the reaction gas is let out is uniformed as much as possible. With this arrangement, within the same carbon nanotube forming surface, the irregularities in the growth of the carbon nanotubes formed on the same carbon nanotube forming surface are reduced.

### BRIEF DESCRIPTION OF DRAWINGS

FIG. 1 is a cross sectional view related to a manufacturing embodiment 1, depicting a concept of carbon nanotube manufacturing apparatus.

FIG. 2 is a cross sectional view related to the manufacturing embodiment 1, depicting the carbon nanotube manufacturing apparatus seen in a different direction.

FIG. 3 is a top view related to the manufacturing embodiment 1, depicting a primary portion of the carbon nanotube manufacturing apparatus.

FIG. 4 is a cross sectional view related to the manufacturing embodiment 1, depicting a relationship between first and second outlets and an object.

FIG. 5 is an electron micrograph related to a comparative example 1, depicting characteristics of carbon nanotubes formed on the object.

FIG. 6 is an electron micrograph related to an example 1, depicting characteristics of carbon nanotubes formed on the object.

FIG. 7 is an electron micrograph related to an example 2, depicting characteristics of carbon nanotubes formed on the object.

FIG. 8 is a cross sectional view related to a manufacturing embodiment 3, depicting a concept of carbon nanotube manufacturing apparatus.

FIG. 9 is a cross sectional view related to a manufacturing embodiment 4, depicting a concept of carbon nanotube manufacturing apparatus.

FIG. 10 is a cross sectional view related to a manufacturing embodiment 5, depicting carbon nanotube manufacturing apparatus seen in a different direction.

FIG. 11 is a cross sectional view related to a manufacturing embodiment 6, depicting a concept of carbon nanotube manufacturing apparatus.

FIG. 12 is a cross sectional view related to a manufacturing embodiment 7, depicting a concept of carbon nanotube manufacturing apparatus.

FIG. 13 is a cross sectional view related to an exemplary embodiment 2, depicting a concept of a carbon nanotube device.

FIG. 14 is a cross sectional view related to the exemplary embodiment 2, depicting a concept of the carbon nanotube device.

FIG. 15A is a cross sectional view related to an exemplary embodiment 3, depicting a concept of a carbon nanotube device.

FIG. 15B is a cross sectional view related to the exemplary embodiment 3, depicting a concept of the carbon nanotube device.

FIG. 16 is a cross sectional view related to an exemplary embodiment 4, depicting a concept of a carbon nanotube device.

FIG. 17 is a cross sectional view related to an exemplary embodiment 5, depicting a concept of a carbon nanotube device.

### REFERENCE SIGNS LIST

The following reference signs respectively denote the following items: 1 . . . object (target object); 11 . . . first carbon nanotube forming surface; 12 . . . second carbon nanotube forming surface; 101 . . . first carbon nanotube; 102 . . . second carbon nanotube; 108 . . . carbon nanotube element; 14 . . . lateral end surface; 15 . . . lateral end surface; 2 . . . apparatus body (base body); 3 . . . path forming member; 30 . . . reaction chamber; 31 . . . first facing wall; 32 . . . second facing wall; 33 . . . first gas outlet path; 34 . . . second gas outlet path; 38 . . . first exit; 39 . . . second exit; 41 . . . first outlet; 42 . . . second outlet; 51 . . . first gas feeding chamber; 52 . . . second gas feeding chamber; 71 . . . first heat source; 72 . . . second heat source; 81 . . . first feeding path; and 82 . . . second feeding path.

### DESCRIPTION OF EMBODIMENTS

In the following description, exemplary embodiments according to the aspects of the invention will be described.

### Exemplary Embodiment 1

### Overview Description

A carbon nanotube device according to an exemplary embodiment 1 includes a carbon nanotube element. The carbon nanotube element includes: an object having a first carbon nanotube forming surface and a second carbon nanotube forming surface that are reversely opposed to each other; first carbon nanotubes formed on the first carbon nanotube forming surface of the object; and second carbon nanotubes formed on the second carbon nanotube forming surface of the object. The first carbon nanotubes and the second carbon nanotubes are different from each other in terms of the properties such as physical properties (including the shapes, dimensions and the like) and/or chemical properties. The properties mentioned above are properties in respect of the carbon nanotubes that may be at least one of length, diameter (thickness), tube number per unit area, number of layers (the carbon nanotubes may have a single-layered tubular structure, a multi-layered tubular structure (such as double- layered tubular structure) or the like), crystallinity (G/D ratio: ratio of G band to D band obtained by Raman spectroscopy), lost portion amount, functional group type, functional group amount, density (density as the group of carbon nanotubes), weight, distribution and others.

When the carbon nanotubes are longer, a larger electrode surface area is typically obtained, and favorable supportability is exhibited. When the carbon nanotubes have a greater diameter, favorable supportability is typically exhibited. When the carbon nanotubes have a smaller diameter, more electrolyte is typically impregnated, and ion conductivity in electrolyte is enhanced. When the tube number of the carbon nanotubes is greater, a larger electrode surface area is typically obtained, and favorable supportability is exhibited. When the tube number of the carbon nanotubes is smaller, the intervals between the adjoining carbon nanotubes are increased, which typically results in increase in impregnated electrolyte and enhancement of ion conductivity in electrolyte. When the crystallinity of the carbon nanotubes is smaller, the supportability is improved due to lost portions of graphene sheets. When the crystallinity of the carbon nanotubes is greater, the graphene sheets become favorable and the conductivity is enhanced. When the density of the carbon nanotubes is greater, a larger electrode surface area is typically obtained, and favorable supportability is exhibited. When the density of the carbon nanotubes is smaller, more electrolyte is typically impregnated, and ion conductivity in electrolyte is enhanced. When the weight of the carbon nanotubes is greater, the enhanced supportability is exhibited. The distribution of the carbon nanotubes affects the supportability.

The favorable supportability mentioned above means that functional materials such as particles are easily bonded to the carbon nanotubes. Taking an example of an Li ion capacitor, a negative electrode potential is reduced due to the favorable supportability for lithium titanate particles (potential control particles), and capacity performance is increased. Taking another example of a high molecular fuel cell, oxidation reaction or reduction reaction at electrodes is accelerated due to the favorable supportability for platinum partic les (catalyst particles), and output performance is increased.

In order to make the characteristics of the first carbon nanotubes different from those of the second carbon nanotubes as described above, it is favorable to change at least one of the elements such as the surface roughness of the object (e.g., substrate), the amount of a catalyst supported on the first carbon nanotube forming surface and the second carbon nanotube forming surface of the object, the composition of the catalyst, the density of the catalyst, the diameter of the catalyst, the flow rate per unit time of a reaction gas, the flow rate ratio of the reaction gas between the first carbon nanotube forming surface and the second carbon nanotube forming surface, the flow velocity, the types of the reaction gas, the temperature of the reaction gas, the flowing direction of the reaction gas, the size or pitch of reaction gas inlets, the temperatures at the first carbon nanotube forming surface and the second carbon nanotube forming surface, and output of the heat source. By lowering the temperature of the object and/or the temperature of the reaction gas relatively to each other, the lost portions of the graphene sheet (a network formed by the conjunction of a plurality of carbon atoms) is relatively increasable, and the crystallinity of the carbon nanotubes is relatively reducible. By adjusting, at the time of manufacturing, the particle diameter of a catalyst held by the substrate, the diameters of the carbon nanotubes are adjustable, or the number of the carbon nanotube layers is adjustable. The density of the carbon nanotubes is easily affected by the number of carbon nanotube layers and/or the tube number of carbon nanotubes per unit area. When there is an increase in the number of the layers and/or the tube number of the carbon nanotubes, the density is increased. The weight of the carbon nanotubes is easily affected by the density of the carbon nanotubes and/or the length of the carbon nanotubes. When the density and the length are great, the weight of the carbon nanotubes is increased.

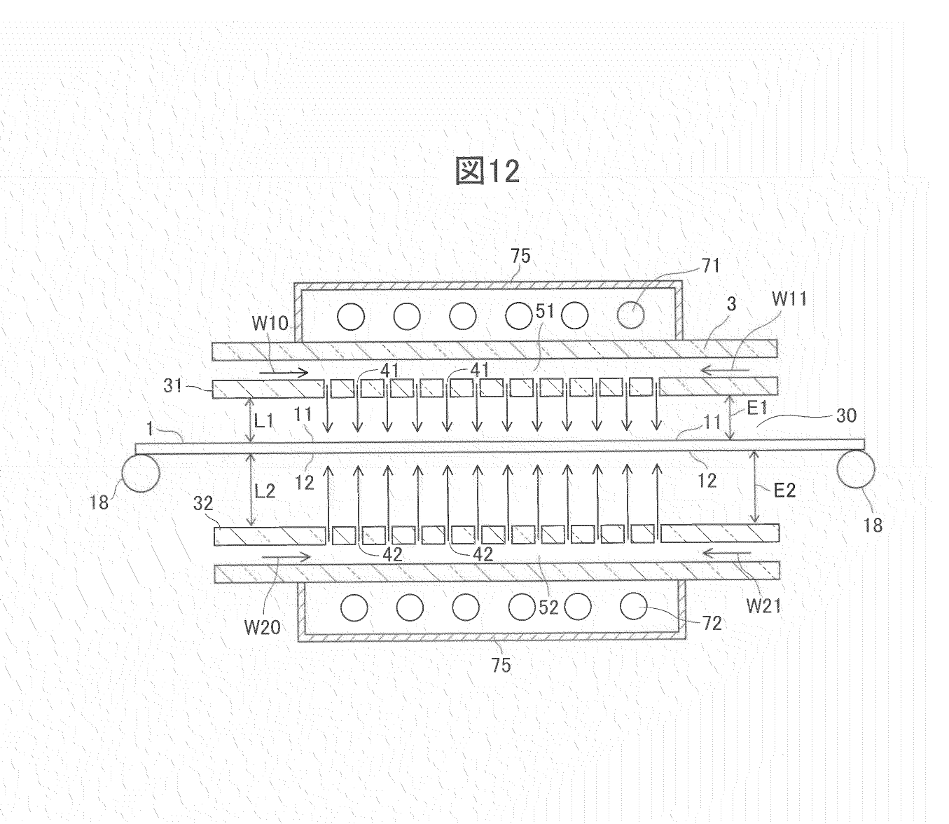

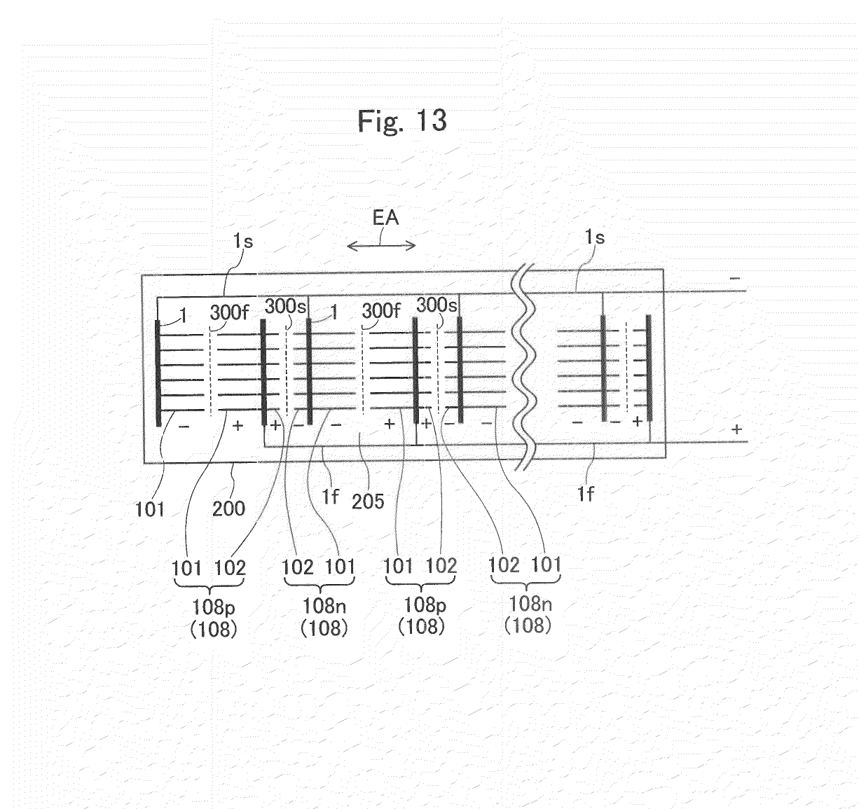

For instance, as depicted in FIGS. 13, 14 and 16, a plurality of carbon nanotube elements may be arranged side by side in such a manner that the first carbon nanotubes of one of the carbon nanotube elements are in opposition to the first carbon nanotubes of another of the carbon nanotube elements that is in the adjoining to the one of the carbon nanotube elements and the second carbon nanotubes of the one of the carbon nanotube elements are in opposition to the second carbon nanotubes of another of the carbon nanotube elements that is in adjoining to the one of the carbon nanotube elements.

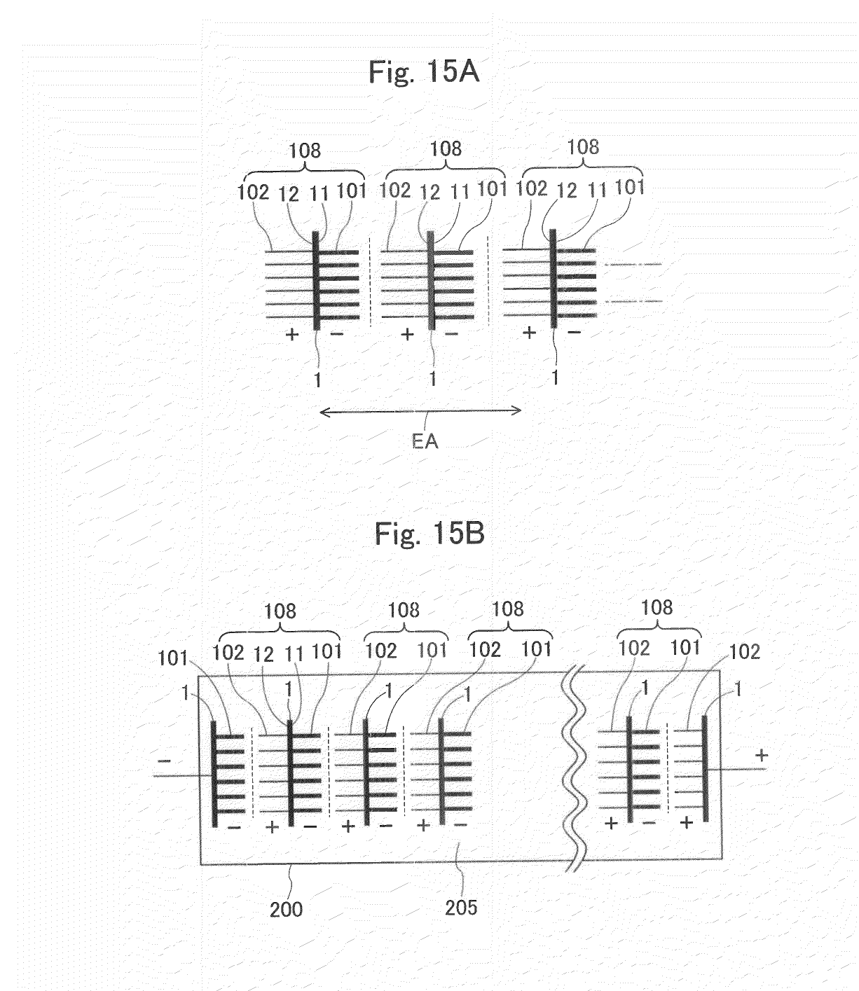

Further, as depicted in FIGS. 15 and 17, a plurality of carbon nanotube elements may be arranged side by side in such a manner that the first carbon nanotubes of one of the carbon nanotube elements are in opposition to the second carbon nanotubes of another of the carbon nanotube elements that is in adjoining to the one of the carbon nanotube elements. When the device is an electric component or an electronic component, the object is preferably conductive. Examples of such object are copper, copper alloy, iron, iron alloy (including stainless steel), titanium, titanium alloy, aluminum, and aluminum alloy. When the device is not an electric component, the object does not have to be conductive. Such carbon nanotube device is applicable not only to capacitors but also devices such as fuel cells, lithium batteries, solar cells and metal-air batteries. This exemplary embodiment provides a new carbon nanotube device including the first carbon nanotubes and the second carbon nanotubes having different characteristics, which is advantageous in making device characteristics hybrid.

### Exemplary Embodiment 2

### Juxtaposition Connection of CNTs having Different Lengths

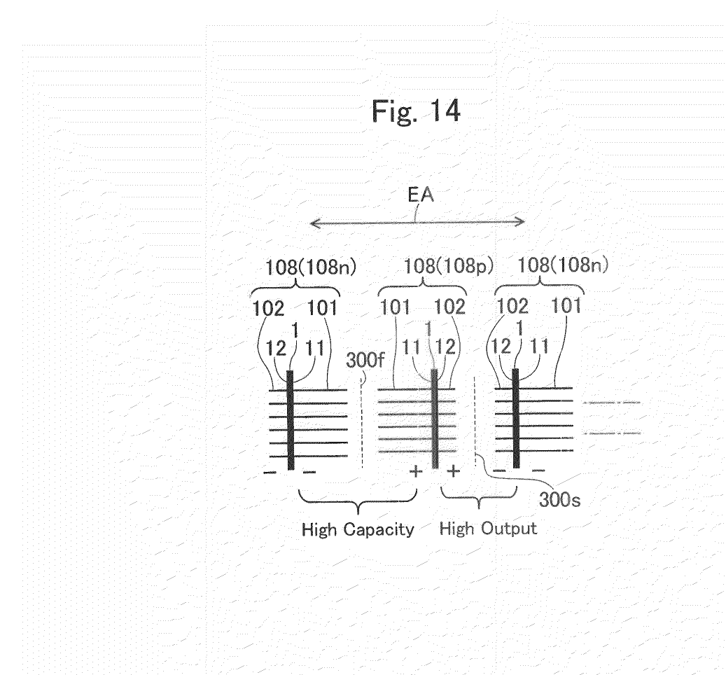

FIGS. 13 and 14 depict a carbon nanotube device according to an exemplary embodiment 2. The carbon nanotube device, which is included in a capacitor that stores electric charges, is provided by so combining a plurality of carbon nanotube elements 108 that CNTs having different lengths are connected in juxtaposition. As depicted in FIG. 14, each carbon nanotube element 108 includes: (i) an object 1 (target object) having a flat first carbon nanotube forming surface 11 and a flat second carbon nanotube forming surface 12 that are reversely opposed to each other; (ii) a plurality of first carbon nanotubes 101 that protrude from the first carbon nanotube forming surface 11 of the object 1 to extend in parallel to one another substantially perpendicularly to the first carbon nanotube forming surface 11; and (iii) a plurality of second carbon nanotubes 102 that protrude from the second carbon nanotube forming surface 12 of the object 1 to extend in parallel to one another substantially perpendicularly to the second carbon nanotube forming surface 12. The carbon nanotube element 108 having the above structure is hermetically sealed in a casing 200 together with electrolyte 205. Examples of the electrolyte 205 are publicly known electrolyte used in capacitors.

The object 1, which has a plate shape, is made of conductive metal(s) such as iron, iron alloy, copper and copper alloy, to exhibit conductivity. The first carbon nanotubes 101 (CNT) and the second carbon nanotubes 102 (CNT) basically have the same characteristics except for the length. The length of the first carbon nanotubes 101 is greater than the length of the second nanotubes 102. The first carbon nanotubes 101 having the greater length have a larger surface area and larger support quantity for supporting substances. The second carbon nanotubes 102 having the smaller length can provide an electrode having an improved ion conductivity.

As depicted in FIG. 13, the plurality of carbon nanotube elements 108 is arranged side by side in a direction indicated by an arrow EA. The carbon nanotube elements 108 depicted in FIG. 13 include: a plurality of positive electrode carbon nanotube elements 108p in which the first carbon nanotubes 101 and the second carbon nanotubes 102 formed on common objects 1 serve as positive electrodes; and a plurality of negative electrode carbon nanotube elements 108n in which the first carbon nanotubes 101 and the second carbon nanotubes 102 formed on common objects 1 serve as negative electrodes. As depicted in FIG. 13, the objects 1 for the plurality of positive electrode carbon nanotube elements 108p are electrically connected to a positive electrode side (+) via a first electrically conductive path 1f. The objects 1 for the plurality of negative electrode carbon nanotube elements 108n are electrically connected to a negative electrode side (−) via a second electrically conductive path 1s.

According to this exemplary embodiment, as depicted in FIG. 13, the first carbon nanotubes 101 and the second carbon nanotubes 102 in the adjoining two carbon nanotube elements 108 are aligned symmetrically with respect to separators 300f and 300s. Specifically, as depicted in FIG. 13, in the adjoining two carbon nanotube elements 108 (108n and 108p), the adjoining two objects 1 are electrically connected to respectively different electrodes. Accordingly, the adjoining elements 108 (108n and 108p) are electrically connected to respectively different electrodes. In addition, the first carbon nanotubes 101 (negative electrode) of the element 108n and the first carbon nanotubes 101 (positive electrode) of the element 108p that adjoins to the element 108n are opposed to each other via the separator 300f. Likewise, the second carbon nanotubes 102 (positive electrode) of the element 108p and the second carbon nanotubes 102 (negative electrode) of the element 108n that adjoins to the element 108p are opposed to each other via the separator 300s.

Accordingly, as depicted in FIG. 13, in the direction in which the plurality of elements 108 is arranged side by side (the direction indicated by the arrow EA), the first carbon nanotubes 101, the first carbon nanotubes 101, the second carbon nanotubes 102, the second carbon nanotubes 102, the first carbon nanotubes 101, the first carbon nanotubes 101, the second carbon nanotubes 102, the second carbon nanotubes 102 . . . are aligned in this order. In other words, as depicted in FIGS. 13 and 14, the first carbon nanotubes 101 and 101 having the same characteristics (i.e., basically the same length) are opposed to each other as different electrodes via the separator 300f. On the other hand, the second carbon nanotubes 102 and 102 having the same characteristics (i.e., basically the same length) are opposed to each other as different electrodes via the separator 300s. In other words, in the adjoining two elements 108n and 108p respectively serving as different electrodes, the first carbon nanotubes 101 and 101 having the same characteristics (the same length) but serving respectively as different electrodes are opposed to each other via the separator 300f. On the other hand, in the adjoining two elements 108n and 108p respectively serving as different electrodes, the second carbon nanotubes 102 and 102 having the same characteristics (the same length) but serving respectively as different electrodes are opposed to each other via the separator 300s. The carbon nanotubes 101 and 102 respectively having the different lengths are connected in juxtaposition as described above.

As depicted in FIG. 13, the length of the first carbon nanotubes 101 is greater than that of the second carbon nanotubes 102. The first carbon nanotubes 101 (i.e., the longer ones) are mutually opposed to each other via the first separators 300f. Due to their relatively greater surface area, the first carbon nanotubes 101 provide a high capacity single cell. On the other hand, the second carbon nanotubes 102 (i.e., the shorter ones) are mutually opposed to each other via the second separators 300s. Due to their low electric resistance, the second carbon nanotubes 102 provide a high output single cell. The separators 300f and 300s exhibit permeability for anions and cations resolvent in electrolyte, as well as high electric insulation.

According to this exemplary embodiment, the high output single cell provided by the shorter carbon nanotubes (having low electric resistance) and the high capacity single cell provided by the longer carbon nanotubes (having great surface area) are layered in juxtaposition. Therefore, even at the cell level, both of the output function and the capacity function are exerted in a hybrid manner. Specifically, as depicted in FIG. 14, the carbon nanotube elements 108 having the high output function and the carbon nanotube elements 108 having the high capacity function are mingled together in a hybrid manner. This exemplary embodiment provides a new carbon nanotube device including the first carbon nanotubes 101 and the second carbon nanotubes 102 having different characteristics, which is advantageous in making device characteristics hybrid. Preferably, when a normal load is applied, electric discharge is made from the high capacity cell, and when a high load is applied, electric discharge is made from the high output cell. According to this exemplary embodiment, the first carbon nanotubes 101 and the second carbon nanotubes 102 may be formed by flowing a reaction gas in a direction substantially perpendicular to the planar direction of the object 1. Alternatively, the first carbon nanotubes 101 and the second carbon nanotubes 102 may be formed by flowing a reaction gas in the planar direction of the object 1.

### Exemplary Embodiment 3

### Series Connection of CNTs having Different Crystallinity

FIGS. 15A and 15B depict a carbon nanotube device according to an exemplary embodiment 3. The carbon nanotube device, which is included in a capacitor that stores electric charges, is provided by combining a plurality of carbon nanotube elements 108. As depicted in FIG. 15A, each carbon nanotube element 108 includes: (i) an object 1 having a flat first carbon nanotube forming surface 11 and a flat second carbon nanotube forming surface 12 that are reversely opposed to each other; (ii) first carbon nanotubes 101 that protrude from the first carbon nanotube forming surface 11 of the object 1 to extend substantially perpendicularly to the first carbon nanotube forming surface 11; and (iii) second carbon nanotubes 102 that protrude from the second carbon nanotube forming surface 12 of the object 1 to extend substantially perpendicularly to the second carbon nanotube forming surface 12. As depicted in FIG. 15A, in the adjoining carbon nanotube elements 108, the first carbon nanotubes 101 and the second carbon nanotubes 102 are aligned asymmetrically with respect to a separator (not depicted).

Accordingly, in the adjoining carbon nanotube elements 108, the first carbon nanotubes 101 and the second carbon nanotubes 102 having different characteristics and serving as different electrodes are connected in series via the separator (not depicted). The carbon nanotubes respectively having different crystallinity are connected in series as described above. Accordingly, as depicted in FIG. 15A, in the direction in which the plurality of elements 108 is arranged side by side (the direction indicated by the arrow EA), the second carbon nanotube 102, the first carbon nanotubes 101, the second carbon nanotubes 102, the first carbon nanotubes 101, the second carbon nanotubes 102, and the first carbon nanotubes 101 are aligned in this order. As depicted in FIG. 15B, the plurality of carbon nanotube elements 108 is arranged side by side. In the carbon nanotube element 108 depicted in FIG. 15B, the first carbon nanotubes 101 formed on the common object 1 serve as the negative electrode while the second carbon nanotubes 102 serve as the positive electrode. By connecting the plurality of carbon nanotube elements 108 in series within the casing 200, a high electromotive force is derivable.

The object 1, which has a plate shape for providing a substrate, is made of conductive metal (s) such as iron, iron alloy, copper, copper alloy, titanium, titanium alloy, aluminum and aluminum alloy, to exhibit conductivity. The first carbon nanotubes 101 and the second carbon nanotubes 102 basically have the same characteristics. However, the crystallinity of the first carbon nanotubes 101 is lower than that of the second carbon nanotubes 102. As described above, the first carbon nanotubes 101 have lower crystallinity. Lower crystallinity is considered to result in more lost portions of the tubular graphene sheets of the carbon nanotubes and in higher supportability for potential control particles. Higher crystallinity results in less lost portions of the tubular graphene sheets of the carbon nanotubes and in higher conductivity. Therefore, according to this exemplary embodiment, by forming the carbon nanotube positive electrode having the higher crystallinity (for the sake of the conductivity) and the carbon nanotube negative electrode having the lower crystallinity on a side by side basis, high output and high capacity are both realized. Particularly when this carbon nanotube device is applied to a lithium ion capacitor, by forming the carbon nanotube positive electrode having the higher crystallinity (for the sake of the conductivity) and the carbon nanotube negative electrode having the lower crystallinity on a side by side basis, high output and high capacity are both realized. Further, by forming the carbon nanotube positive electrode and the carbon nanotube negative electrode at the same time in accordance with the manufacturing embodiment herein, the productivity is increasable. While the crystallinity of the first carbon nanotube 101 is set lower than that of the second carbon nanotube 102 according to this exemplary embodiment, the crystallinity of the second carbon nanotube 102 maybe reversely set lower than that of the first carbon nanotube 101. In FIG. 15A, the casing 200 and the electrolyte 205 are not depicted.

### Exemplary Embodiment 4

### Parallel Connection of CNTs having Different Crystallinity

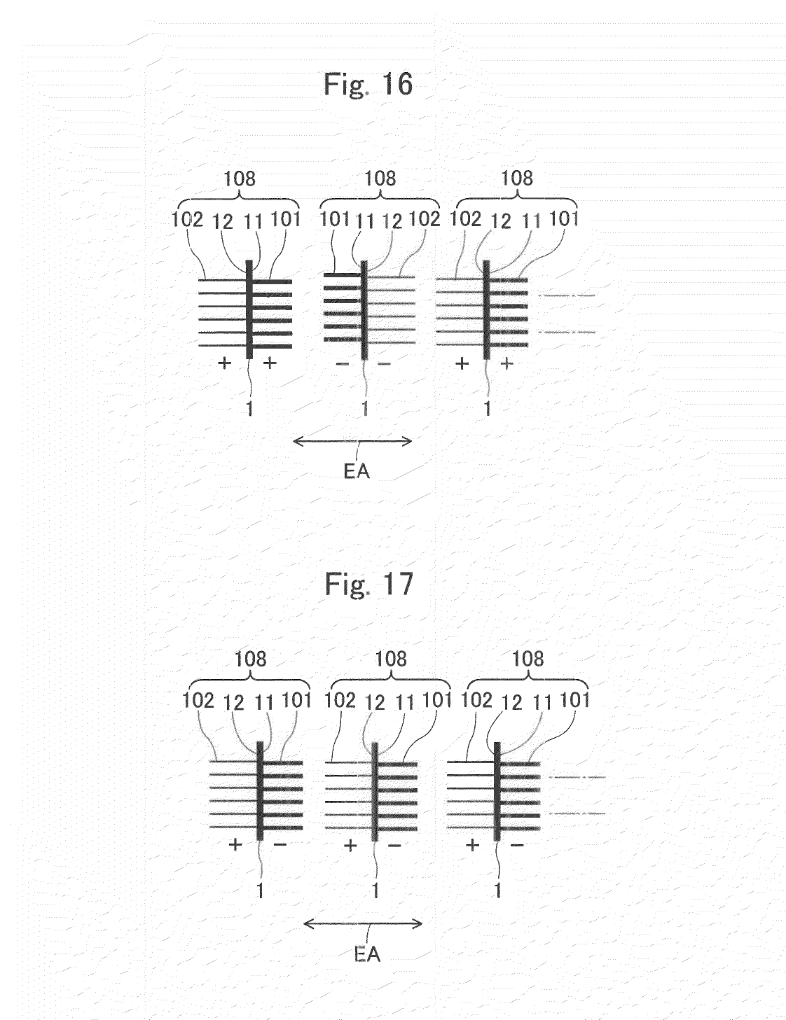

FIG. 16 depicts a carbon nanotube device according to an exemplary embodiment 4. The carbon nanotube device, which is included in a capacitor that stores electric charges, is provided by combining a plurality of carbon nanotube elements 108. As depicted in FIG. 16, each carbon nanotube element 108 includes: (i) an object 1 having a flat first carbon nanotube forming surface 11 and a flat second carbon nanotube forming surface 12 that are reversely opposed to each other; (ii) first carbon nanotubes 101 that protrude from the first carbon nanotube forming surface 11 of the object 1 to extend substantially perpendicularly to the first carbon nanotube forming surface 11; and (iii) second carbon nanotubes 102 that protrude from the second carbon nanotube forming surface 12 of the object 1 to extend substantially perpendicularly to the second carbon nanotube forming surface 12.

According to this exemplary embodiment, as depicted in FIG. 16, in the adjoining carbon nanotube elements 108, the first carbon nanotubes 101 having the lower crystallinity and the second carbon nanotubes 102 having the higher crystallinity are aligned symmetrically with respect to a separator (not depicted). Therefore, as depicted in FIG. 16, in the direction in which the elements 108 are juxtaposed (i.e., the direction indicated by an arrow EA), the second carbon nanotube 102, the first carbon nanotube 101, the first carbon nanotube 101, the second carbon nanotube 102, the second carbon nanotube 102 . . . are aligned in this order. Hence, as depicted in FIG. 16, the first carbon nanotubes 101 and 101 having the lower crystallinity are opposed to each other, while the second carbon nanotubes 102 and 102 having the higher crystallinity are opposed to each other. The first carbon nanotubes 101 having the lower crystallinity typically have a greater surface area.

On the other hand, the second carbon nanotubes 102 having the higher crystallinity have relatively good conductivity, so as to provide favorable tubular graphene sheets. Accordingly, as depicted in FIG. 16, by layering the first carbon nanotubes 101 having the lower crystallinity and the second carbon nanotubes 102 having the higher crystallinity so that the first carbon nanotubes 101 and 101 are opposed to each other while the second carbon nanotubes 102 and 102 are opposed to each other, and by connecting the first carbon nanotubes 101 and the second carbon nanotubes 102 in juxtaposition, the high output function and the high capacity function are exerted in a hybrid manner. This exemplary embodiment provides a new carbon nanotube device including the first carbon nanotubes 101 and the second carbon nanotubes 102 having different characteristics in terms of the crystallinity, which is advantageous in making device characteristics hybrid. While the crystallinity of the first carbon nanotube 101 is set lower than that of the second carbon nanotube 102 according to this exemplary embodiment, the crystallinity of the second carbon nanotube 102 may be reversely set lower than that of the first carbon nanotube 101. In FIG. 16, the casing 200 and the electrolyte 205 are not depicted.

### Exemplary Embodiment 5

### Series Connection of CNTs having Different Thicknesses

FIG. 17 depicts a carbon nanotube device according to an exemplary embodiment 5. First carbon nanotubes 101 having greater diameters (and thus greater thicknesses) typically provide good supportability. Thus, by supporting the particles such as lithium titanate particles, the first carbon nanotubes 101 easily function as negative electrodes. On the other hand, second carbon nanotubes 102 having smaller diameters (and thus smaller thicknesses) are relatively favorable in impregnation of electrolyte. Thus, the second carbon nanotubes 102 are usable as positive electrodes excellent in ion conductivity. As depicted in FIG. 17, by layering the thicker first carbon nanotubes 101 and the thinner second carbon nanotubes 102 such that the first carbon nanotubes 101 are opposed to the second carbon nanotubes 102, and by connecting the first carbon nanotubes 101 and the second carbon nanotubes 102 in series, capacitors having a greater electromotive force are manufacturable at high productivity.

As depicted in FIG. 17, in the adjoining carbon nanotube elements 108, the thicker first carbon nanotubes 101 and the thinner second carbon nanotubes 102 are aligned asymmetrically with respect to a separator (not depicted). Accordingly, as depicted in FIG. 17, in the direction in which the elements 108 are arranged side by side (i.e., direction indicated by an arrow EA), the thinner second carbon nanotube 102, the thicker first carbon nanotube 101, the thinner second carbon nanotube 102, the thicker first carbon nanotube 101, the thinner second carbon nanotube 102 . . . are aligned in this order. While the crystallinity of the first carbon nanotube 101 is set lower than that of the second carbon nanotube 102 according to this exemplary embodiment, the crystallinity of the second carbon nanotube 102 may be reversely set lower than that of the first carbon nanotube 101. In FIG. 17, the casing 200 and the electrolyte 205 are not depicted.

(Exemplification of Manufacturing Method)

For forming the carbon nanotube elements 108 including the carbon nanotubes having different characteristics described above, the following manufacturing methods are exemplified.

(i) Preparing process is made, the preparing process including: a preparation for the object (target object) having the carbon nanotube forming surface on which the carbon nanotubes are formed; a preparation for a gas path forming member that includes: a reaction chamber adapted to accommodate the object; a gas feeding chamber that faces, with a clearance interposed, the carbon nanotube forming surfaces of the object accommodated in the reaction chamber and extends in the planar direction in which the carbon nanotube forming surface extends; a plurality of outlets communicating with the gas feeding chamber and the reaction chamber and adapted to let out the reaction gas in the gas feeding chamber into the reaction chamber; and a preparation for a heat source adapted to heat to a carbon nanotube forming temperature at least one of the carbon nanotube forming surface of the object, the gas path forming member and the reaction gas. Then, (ii) carbon nanotube forming process is made, while at least one of the carbon nanotube forming surface of the target object, the gas path forming member and the reaction gas is heated to the carbon nanotube forming temperature, the reaction gas is fed into the gas feeding chamber, and the reaction gas in the gas feeding chamber is let out through the outlets onto the carbon nanotube forming surface of the object, such that the carbon nanotubes are formed on the carbon nanotube forming surfaces of the object, the reaction gas being let out in a direction intersecting with the planar direction in which the carbon nanotube forming surface of the object within the reaction chamber extends.

In this manufacturing method, when the shortest distance L between the outlets and the common carbon nanotube forming surface of the object is relatively indicated as 100, the shortest distance between each outlet and the common carbon nanotube forming surface at the time of letting out the reaction gas is preferably set within a range of 75 to 125 entirely along the outlets, such that the shortest distance L between each outlet and the carbon nanotube forming surface of the object is uniformed. With this arrangement, the irregularities of the whole first carbon nanotubes are reduced. Likewise, the irregularities of the second carbon nanotubes are reduced.

Preferably, the carbon nanotube forming surface of the object includes a first carbon nanotube forming surface and a second carbon nanotube forming surface, and a first operation through which the carbon nanotubes are formed on the first carbon nanotube forming surface and a second operation through which the carbon nanotubes are formed on the second carbon nanotube forming surface are independently controlled. With this arrangement, by controlling the first operation and the second operation independently of each other, the carbon nanotubes formed on the first carbon nanotube forming surface through the first operation are able to easily exhibit characteristics different from those of the carbon nanotubes formed on the second carbon nanotube forming surface through the second operation. While the first operation and the second operation are performed preferably at the same time in terms of the productivity, the first operation and the second operation may be performed at different timings so as to avoid the temporarily overlapped performance. Further, the first operation and the second operation may be performed at different timings, while allowing the first operation and the second operation to be performed in a partially temporarily overlapped manner.

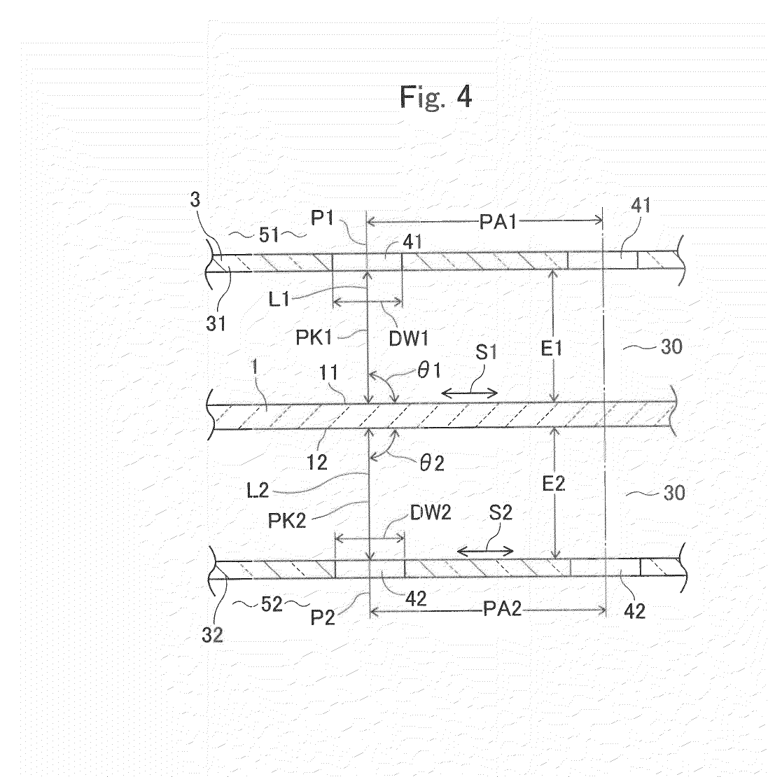

Preferably, the extension line that extends from the center line of the outlets each toward the object is set to intersect with the planar direction in which the carbon nanotube forming surface of the object extends, at an angle within a predetermined angle (equivalent to θ1 and θ2 depicted in FIGS. 4, and θ1 and θ2=70 to 100°). With this arrangement, the irregularities of the whole first carbon nanotubes on the first carbon nanotube forming surface are reduced. The irregularities of the whole second carbon nanotubes on the second carbon nanotube forming surface are reduced.

Preferably: (a) the carbon nanotube forming surface of the object includes the first carbon nanotube forming surface and the second carbon nanotube forming surface positioned respectively at different positions (for instance, when the object is a substrate, at the front surface, back surface or lateral surface of the object); (b) a facing wall includes a first facing wall facing the first carbon nanotube forming surface of the object with a first clearance interposed and a second facing wall facing the second carbon nanotube forming surface of the object with a second clearance interposed; (c) the outlets includes first outlets formed in the first facing wall and second outlets formed in the second facing wall; (d) the gas feeding chamber includes a first gas feeding chamber connected to a first gas feeder and communicating with the first outlets and a second gas feeding chamber connected to a second gas feeder and communicating with the second outlets; and (e) the heat source includes a first heat source adapted to heat to a first carbon nanotube forming temperature at least one of a first reaction gas for forming the carbon nanotubes on the first carbon nanotube forming surface, the first carbon nanotube forming surface of the object and the first gas feeding chamber, and a second heat source adapted to heat to a second carbon nanotube forming temperature at least one of a second reaction gas for forming the carbon nanotubes on the second carbon nanotube forming surface, the second carbon nanotube forming surface of the object and the second gas feeding chamber.

With this arrangement, the first operation for forming the carbon nanotubes on the first carbon nanotube forming surface and the second operation for forming the carbon nanotubes on the second carbon nanotube forming surface are controllable independently of each other.

In this arrangement, by controlling the first operation and the second operation independently of each other, the carbon nanotubes formed on the first carbon nanotube forming surface through the first operation are able to easily exhibit characteristics different from those of the carbon nanotubes formed on the second carbon nanotube forming surface through the second operation. As described above, the first operation and the second operation may be performed at the same time or at different timings.

Preferably, in forming the carbon nanotubes, a first end of the object may be sandwiched by a pair of first installation portions with a second end of the object sandwiched by a pair of second installation portions. By displacing the first installation portions and the second installation portions in a direction in which the first installation portions and the second installation portions are relatively spaced apart from each other along the planar direction of the object, tension is given to the object in the planar direction, thereby restricting the excessive deflection deformation of the object. With this arrangement, even when the flow rate per unit time of the first reaction gas let out from the first outlets is not equated to the flow rate per unit time of the second reaction gas let out from the second outlets, the carbon nanotube forming surfaces of the object is restricted from being displaced in the thickness direction of the object. Also, by giving tension to the object in the planar direction as described above, the carbon nanotubes may be formed on the object. Preferably, the exit of the gas outlet path of the gas path forming member is located at a position opposed to a lateral end surface of the object. In this arrangement, the reaction gas having contacted the carbon nanotube forming surfaces of the object can be let out through the gas outlet path soon after the carbon nanotubes are formed. Accordingly, the consumed gas after the formation of the carbon nanotubes is restricted from remaining in the reaction chamber. This arrangement contributes to good formation of the carbon nanotubes.

In the forming reaction of the carbon nanotubes, carbon sources and processing conditions are not subject to any particular limitations. Examples of the carbon sources adapted to feed carbons for use in forming the carbon nanotubes are aliphatic hydrocarbon such as alkane, alkene and alkine, aliphatic compounds such as alcohol and ether, and aromatic compounds such as aromatic hydrocarbon. Therefore, the carbon sources are exemplified as a CVD method (such as heat CVD method, plasma CVD method and remote plasma CVD method) utilizing alcohol based source gas or hydrocarbon based source gas. Examples of the alcohol based source gas are gas of methyl alcohol, ethyl alcohol, propanol, butanol, pentanol and hexanol. Examples of the hydrocarbon based source gas are methane gas, ethane gas, acethylene gas and propane gas.

### Manufacturing Embodiment 1

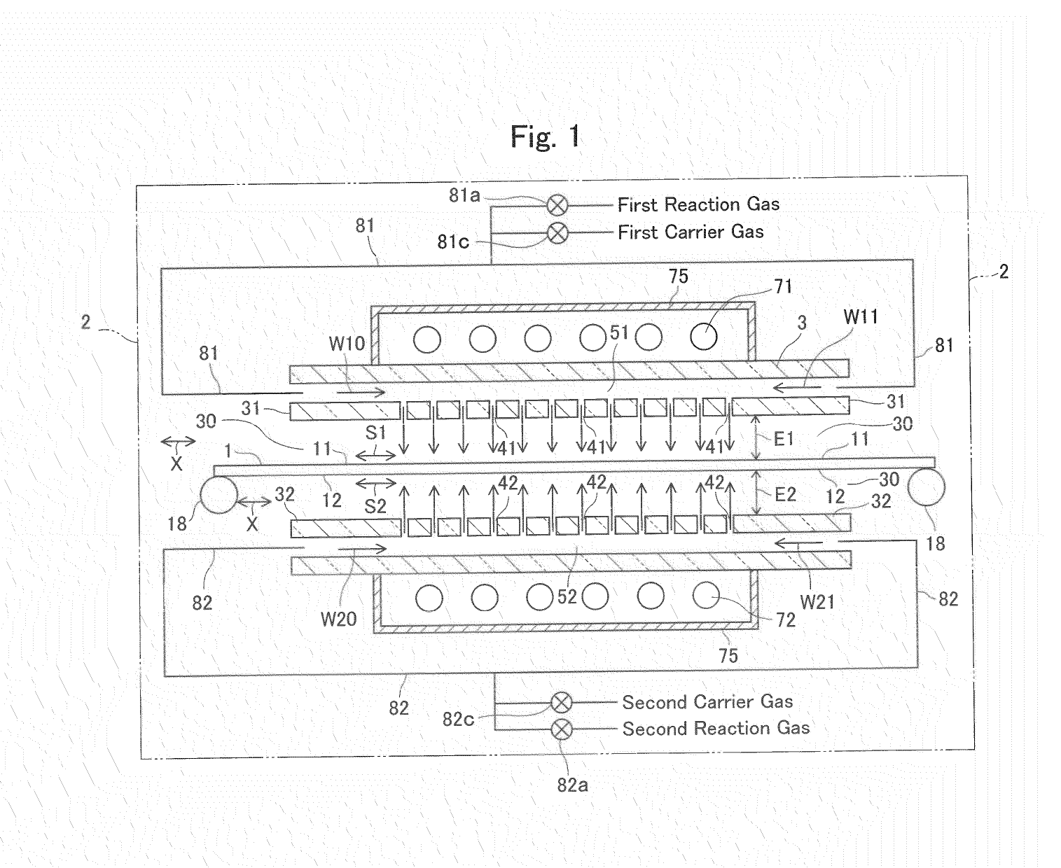

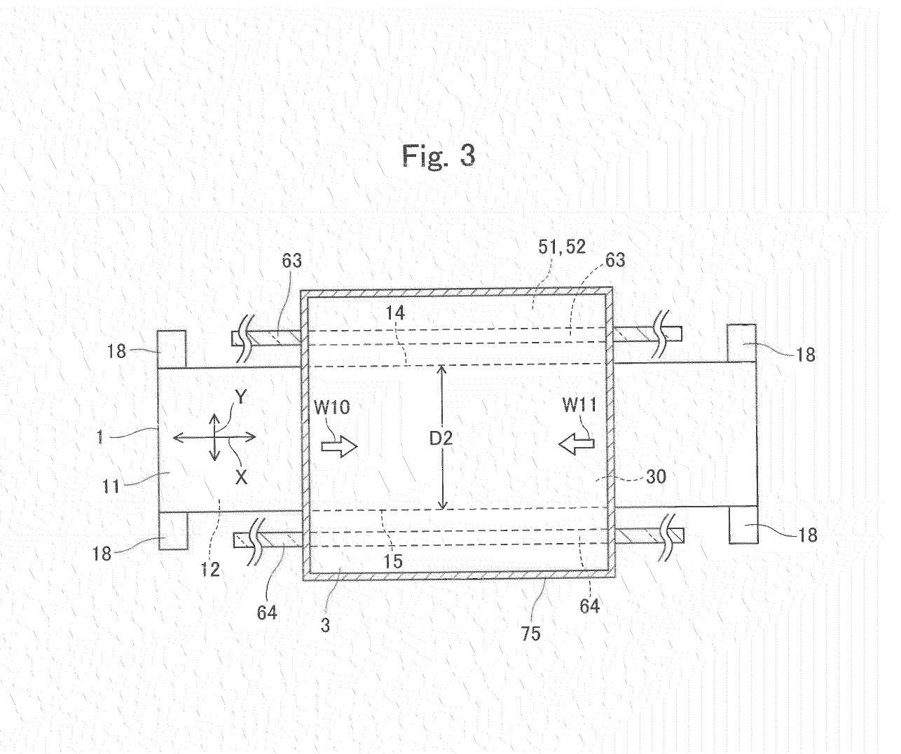

FIGS. 1 to 4 depict a manufacturing embodiment 1. An object 1 (target object) for use in forming the carbon nanotube has a first carbon nanotube forming surface 11 and a second carbon nanotube forming surface 12 that are reversely opposed to each other. Carbon nanotube manufacturing apparatus forms first carbon nanotubes on the first carbon nanotube forming surface 11 and forms second carbon nanotubes on the second carbon nanotube forming surface 12. As depicted in FIGS. 1 to 3, the object 1, which has a flat substrate shape, has the two-dimensionally extending flat first carbon nanotube forming surface 11 and the two-dimensionally extending flat second carbon nanotube forming surface 12. The first carbon nanotube forming surface 11 and the second carbon nanotube forming surface 12 are reversely opposed to each other. Materials of the object 1 are not subject to any particular limitations, examples of which are silicon and metals. Examples of the metals are iron, titanium, copper, aluminum, iron alloy (including stainless steel), titanium alloy, copper alloy and aluminum alloy. As understood from FIG. 3, the first carbon nanotube forming surface 11 and the second carbon nanotube forming surface 12, which are two-dimensionally extending flat surfaces, extend in an X direction as a first direction (longitudinal direction) as well as in a Y direction as a second direction (width direction) that intersects with the X direction (orthogonal to the X direction).

Preferably, a catalyst is provided for the carbon nanotube forming surfaces 11 and 12 of the object 1. An typical example of the catalyst is a transition metal. In particular, metals of V to VIII groups are preferable. Depending on the targeted value of the density of the carbon nanotube aggregate and the like, the metals such as iron, nickel, cobalt, molybdenum, copper, chrome, vanadium, nickel vanadium, titanium, platinum, palladium, rhodium, ruthenium, silver, gold and alloys thereof are usable. The catalyst is preferably an A-B based alloy. Preferably, A is at least one metal selected from iron, cobalt and nickel, and B is at least one metal selected from titanium, vanadium, zirconium, niobium, hafnium and tantalum. In the above example, the catalyst preferably contains at least one of iron-titanium based alloys and iron-vanadium based alloys. Further examples are cobalt-titanium based alloys, cobalt-vanadium based alloys, nickel-titanium based alloys, nickel-vanadium based alloys, iron-zirconium based alloys and iron-niobium based alloys. When an iron-titanium based alloy is used, examples of the iron-titanium alloy is an alloy that contains 10% or more, 30% or more, 50% or more, or 70% or more of titanium in mass ratio (the remainder is iron), and an alloy that contains 90% or less of titanium in mass ratio. When an iron-vanadium based alloy is used, examples of the iron-vanadium alloy is an alloy that contains 10% or more, 30% or more, 50% or more, or 70% or more of vanadium in mass ratio (the remainder is iron), and an alloy that contains 90% or less of vanadium in mass ratio.

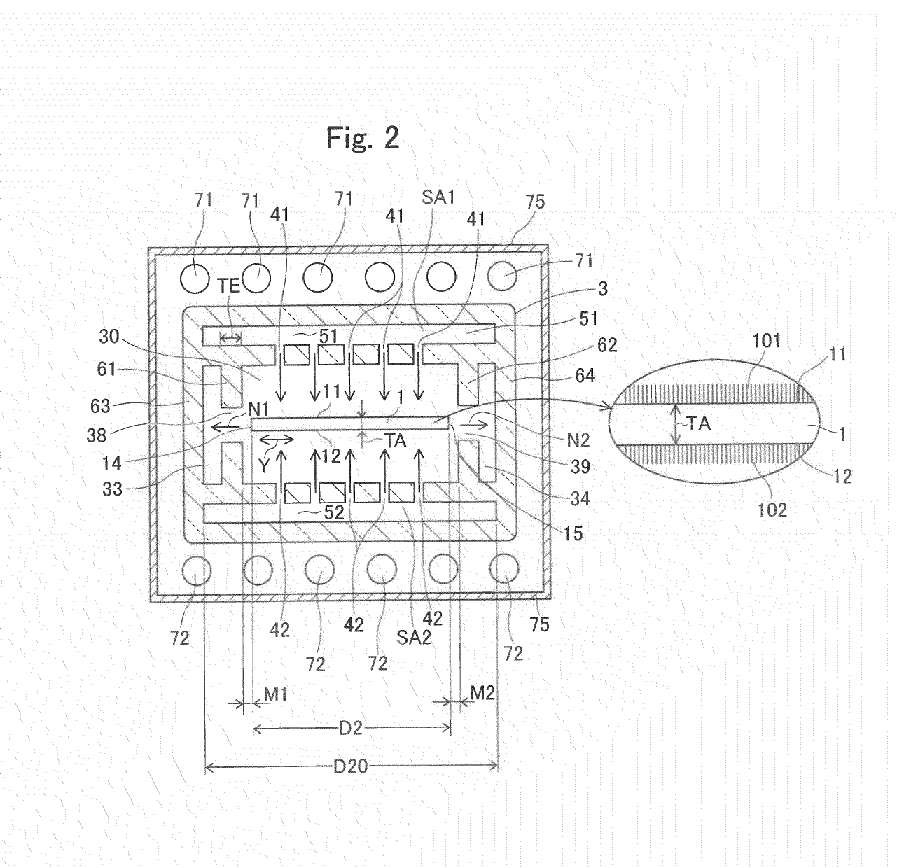

An apparatus body 2 (base body) depicted in FIG. 1 serves as a base body of the carbon nanotube manufacturing apparatus. The apparatus body 2 is provided with a gas path forming member 3 adapted to feed a reaction gas. As depicted in FIGS. 1 and 2, the gas path forming member 3 includes: a reaction chamber 30 having a volume for accommodating the object 1; a first facing wall 31 that faces the first carbon nanotube forming surface 11 of the object 1 with a first clearance E1 (shortest clearance) interposed; and a second facing wall 32 that faces the second carbon nanotube forming surface 12 of the object 1 with a second clearance E2 interposed. E1 may be equalized to E2, or alternatively E1 may be substantially equalized to E2 (e.g., E1/E2=0.85 to 1.15). However, depending on the arrangement, when the characteristics (i.e., the characteristics in respect of the carbon nanotubes that are at least one of: the length; the diameter; the tube number per unit area; the layer number; the crystallinity; the amount of lost portions; the types of functional groups; the amount of functional groups, the density; the weight; the distribution; and the like) of the first carbon nanotubes 101 are made different from those of the second carbon nanotubes 102, E1 may be smaller than E2, or alternatively E1 may be greater than E2.

As depicted in FIGS. 1 and 2, the first facing wall 31, which is substantially in parallel to the first carbon nanotube forming surface 11 of the object 1, two-dimensionally extends in a first planar direction (direction indicated by an arrow S1) in which the first carbon nanotube forming surface 11 of the object 1 extends, and also extends in the X direction and the Y direction described above. This arrangement is advantageous in reducing irregularities in the whole first carbon nanotubes 101 formed on the first carbon nanotube forming surface 11 of the object 1. The second facing wall 32, which is substantially in parallel to the second carbon nanotube forming surface 12 of the object 1, two-dimensionally extends in a planar direction (direction indicated by an arrow S2) in which the second carbon nanotube forming surface 12 of the object 1 extends, and also extends in the X direction and the Y direction described above. This arrangement is advantageous in reducing irregularities in the whole second carbon nanotubes 102 formed on the second carbon nanotube forming surface 12 of the object 1.

As depicted in FIGS. 1 and 2, the gas path forming member 3 includes: a plurality of first outlets 41 formed in the first facing wall 31 to penetrate the first facing wall 31 in its thickness direction; a plurality of second outlets 42 formed in the second facing wall 32 to penetrate the second facing wall 32 in its thickness direction; a first gas feeding chamber 51 that, with use of the first facing wall 31, extends in the first planar direction (S1 direction) in which the first carbon nanotube forming surface 11 of the object 1 extends, and communicates with the first outlets 41; a second gas feeding chamber 52 that, with use of the second facing wall 32, extends in the second planar direction (S2 direction) in which the second carbon nanotube forming surface 12 of the object 1 extends, and communicates with the second outlets 42; a first gas outlet path 33 (see, FIG. 2) communicating with the reaction chamber 30 via a first exit 38 thereof; and a second gas outlet path 34 (see, FIG. 2) communicating with the reaction chamber 30 via a second exit 39 thereof. The first outlets 41 are opposed to the first carbon nanotube forming surface 11 of the object 1. The second outlets 42 are opposed to the second carbon nanotube forming surface 12 of the object 1.

As depicted in FIG. 2, the first gas feeding chamber 51, which is formed to be opposed to the first carbon nanotube forming surface 11 of the object 1, is a box-shaped path that has a greater width dimension D20 than the width dimension D2 of the object 1. The second gas feeding chamber 52, which is formed to be opposed to the second carbon nanotube forming surface 12 of the object 1, is a box-shaped path that has a greater width dimension D20 than the width dimension D2 of the object 1. As depicted in FIG. 2, the box-shaped path is a flat box-shaped path that extends in two-dimensional directions (X direction and Y direction). The above arrangement is for injecting the first reaction gas onto the first carbon nanotube forming surface 11 as perpendicularly and uniformly as possible so that the first carbon nanotubes 101 are formed as uniformly as possible. The above arrangement is also for injecting the second reaction gas onto the second carbon nanotube forming surface 12 as perpendicularly and uniformly as possible so that the second carbon nanotubes 102 are formed as uniformly as possible.

When an longitudinal cross sectional area of the flow path of the first gas feeding chamber 51 is represented by SA1 and an longitudinal cross sectional area of the flow path of the second gas feeding chamber 52 is represented by SA2, SA1 maybe equalized to SA2, or alternatively SA1 may be substantially equalized to SA2. Depending on the arrangement, in order to change the characteristics of the first carbon nanotubes and the second carbon nanotubes, SA1/SA2 may be set within the range of 0.8 to 1.2, or alternatively in the range of 0.9 to 1.1. However, nothing described above shall serve as any limitations. In this manufacturing embodiment, as depicted in FIG. 2, the first gas feeding chamber 51 is located at the upper side of the object 1 while the second gas feeding chamber 52 is located at the lower side of the object 1.

The first outlets 41 are preferably aligned along substantially all of the surfaces of the first facing wall 31 (except for the peripheries) in a zigzag alignment substantially at equal intervals. With this arrangement, the first reaction gas is injected as uniformly as possible, which contributes to the reduction in the irregularities of the whole first carbon nanotubes 101 formed on the first carbon nanotube forming surface 11. The alignment of the first outlets 41 is not limited to a zigzag alignment, but may be any other scattered alignment in the first facing fall 31 in short, as long as the alignment contributes to the reduction in the irregularities of the whole first carbon nanotubes 101. Likewise, the second outlets 42 are preferably aligned along the second facing wall 32 in a zigzag alignment substantially at equal intervals. This arrangement contributes to the reduction in the irregularities of the second carbon nanotubes 102 formed on the second carbon nanotube forming surface 12. The alignment of the second outlets 42 is not limited to a zigzag alignment.

As understood from FIG. 4, although depending on the size and the like of the object 1, the first outlets 41 are provided by circular holes having inner diameters DW1 (e.g., 0.2 to 8 millimeters, 0.3 to 5 millimeters). When a pitch between the center axes P1 of the most adjoining first outlets 41 is represented by PA1 and the inner diameter of each first outlet is represented by DW1, the following relationship is satisfied: pitch PA1=DW1×α1. The “α1” may be set within the range of 2 to 50 or within the range of 3 to 25. However, nothing described above shall serve as any limitations. The same is true of an inner diameter DW2 of each second outlet 42 and a pitch PA2 between the center axes P2 of the second outlets 42. Further, in order to introduce the source gas uniformly onto the surface of an object having a greater area, the pitches may be gradually reduced in accordance with the remoteness of the gas feeding positions, or the hole diameter may be increased.

According to this manufacturing embodiment, as understood from FIG. 4 (which is a cross sectional view depicting a thickness of the object 1), an extension PK1 that extends from the center axis P1 of the first outlets 41 each toward the first carbon nanotube forming surface 11 of the object 1 is preferably set to intersect with the planar direction (S1 direction) in which the first carbon nanotube forming surface 11 of the object 1 extends, at an angle within a first predetermined angle 01 (θ1=70 to 110°), more specifically at an angle within θ1=85 to 95°. Also as depicted in FIG. 4, an extension PK2 that extends from the center axis P2 of the second outlets 42 each toward the second carbon nanotube forming surface 12 of the object 1 is preferably set to intersect with the planar direction (S2 direction) in which the second carbon nanotube forming surface 12 of the object 1 extends, at an angle within a second predetermined angle θ2 (θ2=70 to 110°), more specifically at an angle within θ2=85 to 95°. For the formation of the better carbon nanotubes, θ1 and θ2 may be set within the range of 88 to 92, more particularly at 90.

As depicted in FIG. 2, in the gas path forming member 3, the first facing wall 31 and the second facing wall 32 are connected with each other by a first sub wall 61 and a second sub wall 62. The first exit 38 of the reaction chamber 30 is formed in the first sub wall 61 so as to be close to and opposed to the first lateral end surface 14 of the object 1. The second exit 39 of the reaction chamber 30 is formed in the second sub wall 62 so as to be close to and opposed to the second lateral end surface 15 of the object 1. As depicted in FIG. 2, in an arrangement where the thickness TA of the object 1 is relatively great, when the distance between the first exit 38 and the lateral end surface 14 is represented by M1, the distance between the second exit 39 and the lateral end surface 15 is represented by M2 and the thickness of the object 1 is represented by TA, M1 may exemplarily satisfy (0.3 to 7)×TA, or alternatively (0.5 to 5)×TA. However, nothing described above shall serve as any limitations. When the thickness of the first sub wall 61 is represented by TE, M1 may exemplarily satisfy (0.3 to 7)×TE, or alternatively (0.5 to 5)×TE. However, nothing described above shall serve as any limitations.

As described above, while opposed to the lateral end surface 14 of the object 1, the first exit 38 approaches the lateral end surface 14. Thus, this arrangement is advantageous for shortly letting out the reaction gas used for forming the carbon nanotubes 101 and 102 through the first exit 38 into the first gas outlet path 33. Likewise, M2 may exemplarily satisfy (0.3 to 5)×TA, or alternatively (0.5 to 2)×TA. In this arrangement, while opposed to the lateral end surface 15 of the object 1, the second exit 39 approaches the lateral end surface 15. Thus, this arrangement is advantageous for shortly letting out the reaction gas used for forming the carbon nanotubes 101 and 102 through the second exit 39 into the second gas outlet path 34.

In respect of the first carbon nanotubes 101 and the second carbon nanotubes 102, M1 may be equalized to M2, or M1 may be substantially equalized to M2. Alternatively, M1 may be smaller than M2, or M1 may be greater than M2. As depicted in FIG. 2, the first gas outlet path 33, which is formed with use of the first sub wall 61 and a first lateral wall 63 located further outward than the first sub wall 61, is connected to drain (not depicted). The second gas outlet path 34, which is formed with use of the second sub wall 62 and a second lateral wall 64 located further outward than the second sub wall 62, is connected to the drain.

Further, the apparatus body 2 is provided with a first heat source 71 adapted to heat to a carbon nanotube forming temperature (e.g., approximately 400 to 1000° C., 550 to 700° C.) at least one of the first carbon nanotube forming surface 11 of the object 1, the gas path forming member 3 and the first reaction gas in the first gas feeding chamber 51. The apparatus body 2 is also provided with a second heat source 72 adapted to heat to a carbon nanotube forming temperature at least one of the second carbon nanotube forming surface 12 of the object 1, the gas path forming member 3 and the second reaction gas in the second gas feeding chamber 52. As depicted in FIG. 2, the heat sources 71 and 72 are located outside of the gas feeding chambers 51 and 52. Therefore, the heat sources 71 and 72 are advantageously usable for heating the entirety of the gas feeding chambers 51 and 52 and the entirety of the path forming member 3. The heating temperature affects the crystallinity of carbon nanotubes. When the heating temperature is relatively low, the lost portions in graphene sheets are increased, which will result in the reduction of the crystallinity of the carbon nanotubes.

The first heat source 71, which is located outside of the first gas feeding chamber 51 (upper side of the first gas feeding chamber 51), is preferably provided by a lamp heater adapted to emit near-infrared light. The second heat source 72, which is located outside of the second gas feeding chamber 52 (lower side of the second gas feeding chamber 52), is preferably provided by a lamp heater adapted to emit near-infrared light. The heat sources 71 and 72 are capable of heating the path forming member 3 itself as well as the reaction gas within the path forming member 3. The entirety of the path forming member 3 is preferably made of a near-infrared light transmissive material such as quartz glass. With this arrangement, the first heat source 71 and the second heat source 72 are capable of heating the object 1 within the reaction chamber 30 to the carbon nanotube forming temperature. The outward surfaces of the heat sources 71 and 72 are covered with a covering member 75. The first heat source 71 and the second heat source 72 are preferably controllable with use of a controller independently of each other. This arrangement is advantageous for controlling the temperature T1 of the first carbon nanotube forming surface 11 of the object 1 and the temperature T2 of the second carbon nanotube forming surface 12 of the object 1 independently of each other.

When the object 1 is made of iron, iron alloy or the like to exhibit conductivity and permeability, the first heat source 71 and the second heat source 72 may be induction heater adapted to heat the object 1 by induction heating. When induction heating is employed, owing to its skin effect, the surfaces of the first carbon nanotube forming surface 11 and the second carbon nanotube forming surface 12 are more intensely heated within a shorter period of time. Still other heating method may be employed.

As depicted in FIG. 1, both ends of the first gas feeding chamber 51 are in communication with each other via a first feeding path 81 adapted to feed the first reaction gas and a first carrier gas. The first feeding path 81 is provided with a first feeding valve 81a for use in the first reaction gas and a first feeding valve 81c for use in the first carrier gas. Both ends of the second gas feeding chamber 52 are in communication with each other via a second feeding path 82 adapted to feed the second reaction gas and a second carrier gas. The second feeding path 82 is provided with a second feeding valve 82a for use in the second reaction gas and a second feeding valve 82c for use in the second carrier gas. The first feeding path 81 and the second feeding path 82 are preferably provided with a flowmeter adapted to measure the flow rate of each fed gas.

In the following description, steps for forming the carbon nanotubes will be described. First of all, the catalyst is preferably supported on the first carbon nanotube forming surface 11 of the object 1 and the second carbon nanotube forming surface 12 of the object 1. The catalyst may be formed on the first carbon nanotube forming surface 11 of the object 1 and the second carbon nanotube forming surface 12 of the object 1 by deposition, sputtering, dipping or the like. After that, the steps for forming the carbon nanotubes are performed. Specifically, as depicted in FIGS. 1 and 2, the object 1 is placed in the reaction chamber 30 via an installation portion 18. The installation portion 18 may be a fixed portion or a transfer roller. When the installation portion 18 is a fixed portion, the carbon nanotubes are formed with the object 1 fixed thereon. When the installation portion 18 is a transfer roller, the carbon nanotubes 11 and 12 are sequentially formed while the object 1 is being sequentially transferred in a transferring direction, which contributes to enhancement of the productivity. In the steps for forming the carbon nanotubes, the reaction chamber 30 is preliminarily subjected to vacuuming.

Further, by turning on the first heat source 71 and the second heat source 72, the first carbon nanotube forming surface 11 of the object 1 and the second carbon nanotube forming surface 12 of the object 1 are preliminarily heatedup to the predetermined temperature (e.g., 300 to 600° C., or 500 to 600° C.). In this state, the carrier gas (argon gas or nitrogen gas) is fed into the reaction chamber 30 from the first feeding path 81 via the first gas feeding chamber 51 and the first outlets 41, and the carrier gas is fed into the reaction chamber 30 from the second feeding path 82 via the second gas feeding chamber 52 and the second outlets 42. Then, the pressure in the reaction chamber 30 is adjusted.

Subsequently, the first reaction gas is fed to the first gas feeding chamber 51 via the first feeding path 81, and the second reaction gas is fed to the second gas feeding chamber 52 via the second feeding path 82. The first reaction gas fed in the first gas feeding chamber 51 is injected through the first outlets 41 to collide onto the first carbon nanotube forming surface 11 of the object 1. The second reaction gas fed in the second gas feeding chamber 52 is injected through the second outlets 42 to collide onto the second carbon nanotube forming surface 12 of the object 1. The amounts and types of the first reaction gas and the second reaction gas may be the same.

As understood from FIG. 2, when the steps for forming the carbon nanotubes described above is performed, the first carbon nanotubes 101 are formed on the first carbon nanotube forming surface 11 of the object 1, and the second carbon nanotubes 102 are formed on the second carbon nanotube forming surface 12 of the object 1. The first carbon nanotubes 101 are basically grown to be substantially perpendicular to the first carbon nanotube forming surface 11. The second carbon nanotubes 102 are basically grown to be substantially perpendicular to the second carbon nanotube forming surface 12. When the shortest distance L1 (depicted in FIG. 4) from the first outlets 41 to the common first carbon nanotube forming surface 11 of the object 1 at the time of injecting the first reaction gas is relatively indicated as 100, in respect of the first outlets 41 each, the shortest distance is set within the range of 75 to 125.

Specifically, in respect of each first outlet 41, the shortest distance is preferably set within the range of 90 to 110 (in particular, within the range of 95 to 105, 100). With this arrangement, with respect to the first outlets 41 each, the shortest distances L1 from the first outlets 41 to the first carbon nanotube forming surface 11 of the object 1 are uniformed as much as possible. In this arrangement, the first carbon nanotubes 101 are favorably formed on the first carbon nanotube forming surface 11.

Likewise, when the shortest distance L2 (depicted in FIG. 4) from the second outlets 42 to the common second carbon nanotube forming surface 12 of the object 1 at the time of injecting the second reaction gas is relatively indicated as 100, in respect of the second outlets 42 each, the shortest distance is set within the range of 75 to 125. Specifically, in respect of each second outlet 42, the shortest distance is preferably set within the range of 90 to 110 (in particular, within the range of 95 to 105). With this arrangement, with respect to the second outlets 42 each, the shortest distances L2 from the second outlets 42 to the second carbon nanotube forming surface 12 of the object 1 are uniformed as much as possible. In this arrangement, the second carbon nanotubes 102 are favorably formed on the second carbon nanotube forming surface 12.

According to this manufacturing embodiment described above, the flow rate per unit time of the first reaction gas is basically set to be different from the flow rate per unit time of the second reaction gas. Accordingly, the difference between the first carbon nanotubes 101 and the second carbon nanotubes 102 in the properties (at least one of, for instance, length, diameter, tube number per unit area, number of layers, crystallinity, lost portion amount, functional group type, functional group amount, density, weight, distribution and others) is increasable. In this arrangement, the output from the heat source 71 may be set to be different from the output from the heat source 72. Further, in order to change the characteristics of the first carbon nanotubes 101 and the second carbon nanotubes 102, the catalyst supported on the first carbon nanotube forming surface 11 of the object 1 and the second carbon nanotube forming surface 12 of the object 1 is also basically changeable in respect of the amount to be supported, the supported density and the composition.

The “supported density” means the weight of the catalyst per unit area of the carbon nanotube forming surface. According to this manufacturing embodiment, in the steps for forming the carbon nanotubes, the first gas feeding chamber 51 is fed with the first reaction gas from the directions that are directed oppositely to each other (the directions indicated by arrows W10 and W11) as depicted in FIG. 1. This arrangement contributes to the reduction in the irregularities of the first carbon nanotubes 101 formed on the first carbon nanotube forming surface 11 of the object 1. In addition, as depicted in FIG. 1, the second gas feeding chamber 52 is also fed with the second reaction gas from the direction that are directed oppositely to each other (the directions indicated by arrows W20 and W21). This arrangement contributes to the reduction in the irregularities of the carbon nanotubes formed on the second carbon nanotube forming surface 12 of the object 1. When the forming of the first carbon nanotubes 101 and the second carbon nanotubes 102 is completed, the object 1 is taken out from the reaction chamber 30.

According to the manufacturing embodiment described above, the first operation for forming the first carbon nanotubes 101 on the first carbon nanotube forming surface 11 of the object 1 with use of the first reaction gas, and the second operation for forming the second carbon nanotubes 102 on the second carbon nanotube forming surface 12 of the object 1 with use of the second reaction gas, are controllable independently of each other. Specifically, the valves 81a and 82a depicted in FIG. 1 are controllable independently of each other. The valves 81c and 82c are controllable independently of each other. The heating temperatures respectively by the heat sources 71 and 72 are controllable independently of each other. By independently controlling the first operation and the second operation as described above, the characteristics of the first carbon nanotubes 101 formed on the first carbon nanotube forming surface 11 through the first operation are made different from the characteristics of the second carbon nanotubes 102 formed on the second carbon nanotube forming surface 12 through the second operation. In addition, the outputs of the heat sources 71 and 72 each are also controllable independently.

As understood from FIG. 2, in this manufacturing embodiment, the first exit 38 of the reaction chamber 30 of the gas path forming member 3 is positioned at a position opposed to the lateral end surface 14 of the object 1. The second exit 39 is positioned at a position opposed to the lateral end surface 15 of the object 1. According to this arrangement, the first reaction gas having contacted the first carbon nanotube forming surface 11 of the object 1 is let out from the first exit 38 and the second exit 39 in the direction indicated by the arrows N1 and N2 to be exhausted into the gas outlet paths 33 and 34, soon after the first carbon nanotubes 101 are formed on the first carbon nanotube forming surface 11. Accordingly, the consumed gas after the formation of the first carbon nanotubes 101 is restricted from remaining in the reaction chamber 30. This arrangement contributes to good formation of the first carbon nanotubes 101.

Likewise, the second reaction gas having collided on and contacted the second carbon nanotube forming surface 12 of the object 1 is let out from the first exit 38 and the second exit 39 in the direction indicated by the arrows N1 and N2 to be exhausted into the gas outlet paths 33 and 34, soon after the second carbon nanotubes 102 are formed on the second carbon nanotube forming surface 12. Accordingly, the consumed gas after the formation of the second carbon nanotubes 102 is restricted from remaining in the reaction chamber 30. This arrangement contributes to good formation of the second carbon nanotubes 102.

### Manufacturing Embodiment 2

This manufacturing embodiment basically includes the same arrangements as the manufacturing embodiment 1, and provides the same advantages and effects as the manufacturing embodiment 1. In the following description, the difference of this manufacturing embodiment from the manufacturing embodiment 1 will be mainly described. A first operation for forming first carbon nanotubes 101 on a first carbon nanotube forming surface 11 of an object 1 with use of a first reaction gas, and a second operation for forming second carbon nanotubes 102 on a second carbon nanotube forming surface 12 of the object 1 with use of a second reaction gas, are controlled independently of each other. The first operation and the second operation are controlled independently of each other. With this arrangement, the characteristics of the first carbon nanotubes 101 formed on the first carbon nanotube forming surface 11 through the first operation is made different from the characteristics of the second carbon nanotubes 102 formed on the second carbon nanotube forming surface 12 through the second operation.

In steps for forming the carbon nanotubes, examples of the independent control are: (a) to change the feeding flow rate V1 per unit time of the first reaction gas and the feeding flow rate V2 per unit time of the second reaction gas; (b) to change a temperature Ti of the first carbon nanotube forming surface 11 and a temperature T2 of the second carbon nanotube forming surface 12 by changing the outputs of a first heat source 71 and a second heat source 72 each; (c) to change the amount and/or composition of a catalyst supported on the first carbon nanotube forming surface 11 and the second carbon nanotube forming surface 12; and (e) to change the composition of the first reaction gas and the second reaction gas. The independent control may at least one of the above (a) to (e).

Accordingly, the first carbon nanotubes 101 formed on the first carbon nanotube forming surface 11 are made relatively long while the second carbon nanotubes 102 formed on the second carbon nanotube forming surface 12 are made relatively short. Conversely, the first carbon nanotubes 101 may be shorter than the second carbon nanotubes 102, while the second carbon nanotubes 102 may be relatively longer than the first carbon nanotubes 101. Alternatively, the first carbon nanotubes 101 formed on the first carbon nanotube forming surface 11 are made relatively denser than the second carbon nanotubes 102, while the second carbon nanotubes 102 formed on the second carbon nanotube forming surface 12 are made relatively less dense than the first carbon nanotubes 101. The other way around may be is also applicable.

When the carbon nanotube device is applied to a capacitor electrode and the carbon nanotubes are long, the carbon nanotube device provides a greater surface area, so that high storage capacity is expectable. When the carbon nanotubes are short, enhancement in responsiveness is expectable. The object 1 may be made of silicon or metals. Examples of the metals are iron, titanium, copper, aluminum, iron alloy (including stainless steel), titanium alloy, copper alloy and aluminum alloy. The first operation and the second operation may be implemented so that different operations are performed depending on the material of the object 1.

### EXAMPLES

### Example 1

### Flow Rate Independent Control

Example 1 was prepared with use of the carbon nanotube manufacturing apparatus depicted in FIGS. 1 to 4.

(Object 1) In Example 1, the first carbon nanotubes 101 formed on the first carbon nanotube forming surface 11 of the object 1 were made different from the second carbon nanotubes 102 formed on the second carbon nanotube forming surface 12 in terms of the length. The object 1 was a silicon substrate having 0.5-millimeter of thickness. The silicon substrate was a polished substrate. In respect of the first carbon nanotube forming surface 11 and the second carbon nanotube forming surface 12 of the silicon substrate, the surface roughness was Ra5 nanometer.

(Preliminary Processing) As the first step, the surfaces of the object 1 underwent a water repellent processing. The processing agent was an agent in which 5 volume % of hexaorganosilazane was blended in toluene. The object 1 was dipped in the processing agent for 30 minutes. After that, the object 1 was taken out from the processing agent, and dried naturally. As the second step, the first carbon nanotube forming surface 11 and the second carbon nanotube forming surface 12 of the object 1 were applied with a coating agent by dip coating method, and a 30-nanometer thin film of iron-titanium alloy was formed. The catalyst is considered to have formed an island shape. The coating agent was prepared by dispersing iron-titanium alloy particles (Fe:80%, Ti:20% in mass ratio) in hexane, and adjusting the concentration so that the absorbance became 0.3 when measured with a visible spectrophotometer (manufactured by WPA Corporation, CO7500) under the measurement conditions of wavelength of 680 nanometers. In the dip coating method, dipping was conducted at normal temperature in the atmosphere. Then, the object 1 was pulled out at a speed of 3 millimeters per minute. After the object was pulled out, hexane was shortly evaporated through natural drying.

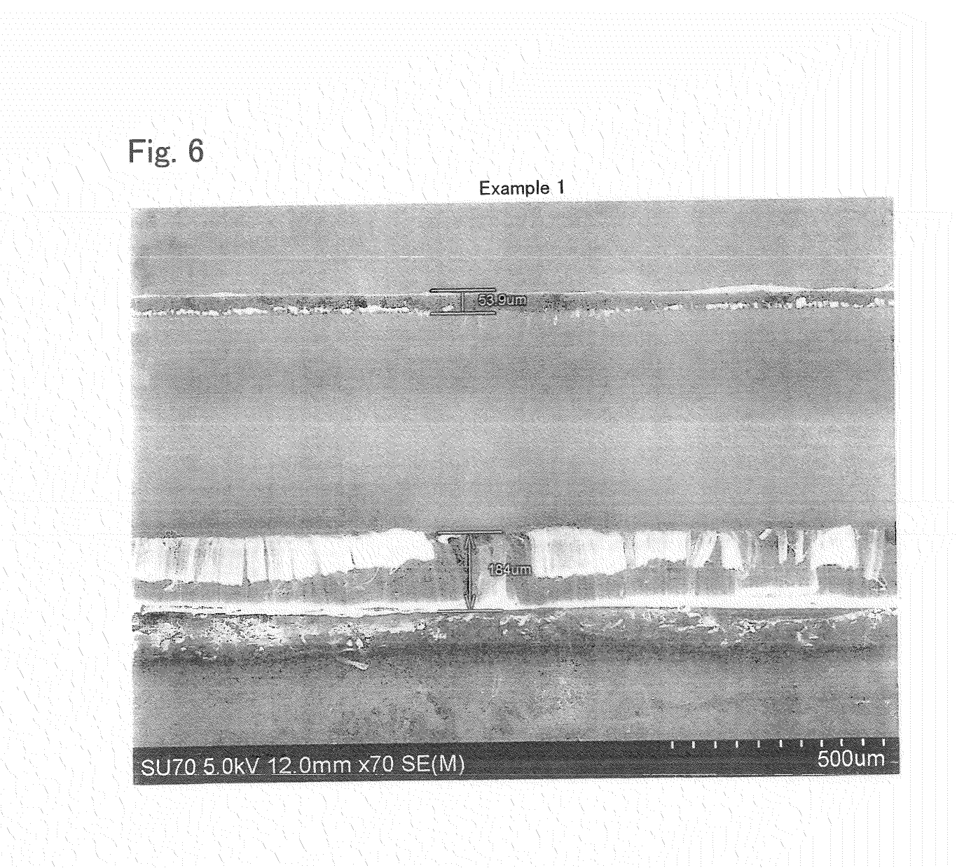

(CNT Formation) With use of the carbon nanotube manufacturing apparatus including the heat CVD device structured as depicted in FIGS. 1 to 4, the carbon nanotubes were formed. Preliminarily, the reaction chamber 30 was vacuumed to 10 Pa. In this reaction chamber 30, nitrogen gas serving as the carrier gas was introduced from the both surfaces of the object 1 at 5000 cc/minute, and the pressure in the reaction chamber 30 was adjusted to 1×10⁵ Pa. After the surface temperature of the object 1 was raised to 600° C., the reaction gas serving as carbon source (acethylene gas) was introduced from the both surfaces of the object 1 for 6 minutes. At that time, the reaction gas was introduced into the upper-positioned first gas feeding chamber 51 at 400 cc/minute, while the reaction gas was introduced into the lower-positioned second gas feeding chamber 52 at 1000 cc/minute. The introduction of the reaction gas lasted for 6 minutes. Through the above operations, the carbon nanotubes were formed on both the first carbon nanotube forming surface 11 and the second carbon nanotube forming surface 12 of the object 1. FIG. 6 depicts the formed carbon nanotubes. The first carbon nanotubes 101 were approximately 54 μm long while the second carbon nanotubes 102 were approximately 184 As is understandable from the above, the more the flow rate per unit time of the reaction gas is, the longer the carbon nanotubes become.

### Comparative Example 1

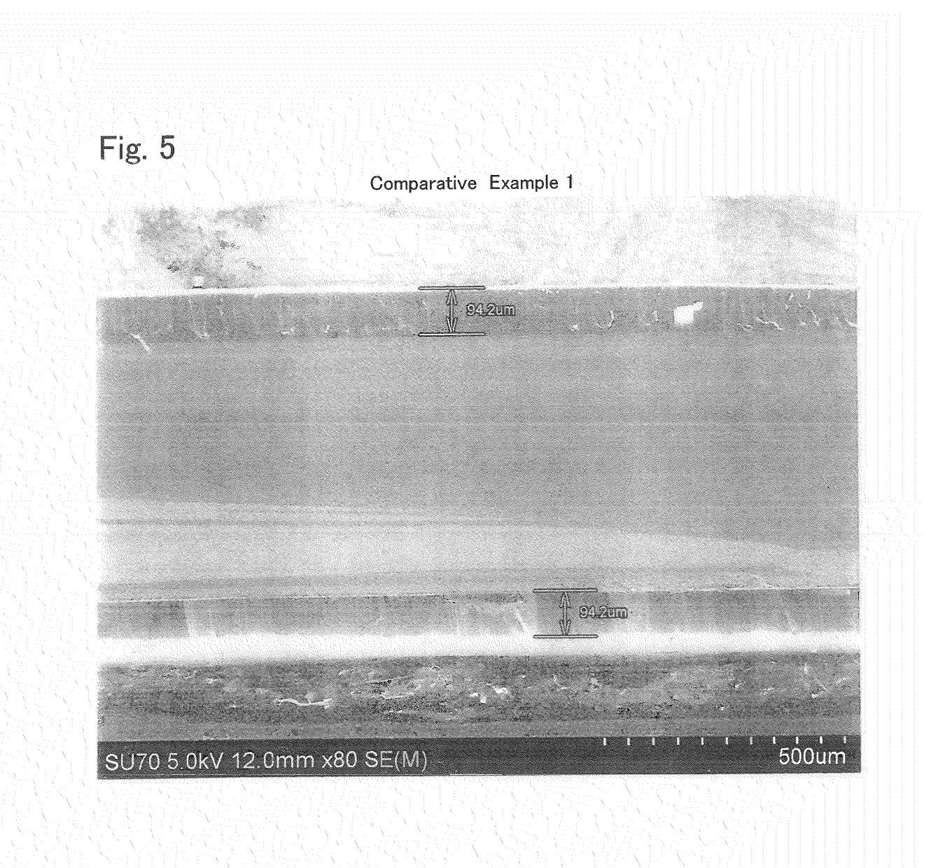

(CNT Formation) With use of the carbon nanotube manufacturing apparatus including the heat CVD device structured as depicted in FIGS. 1 to 4, the carbon nanotubes were formed. Preliminarily, the reaction chamber 30 was vacuumed to 10 Pa. In this reaction chamber 30, nitrogen gas serving as the carrier gas was introduced from the both surfaces of the object 1 at 5000 cc/minute, and the pressure in the reaction chamber 30 was adjusted to 1×10⁵ Pa. After the surface temperature of the object 1 was raised to 600° C., the reaction gas serving as carbon source (acethylene gas) was introduced from the both surfaces of the object 1 for 6 minutes. At that time, the introduction of the reaction gas lasted for 6 minutes at 1000 cc/minute with respect to both surfaces of the object 1. Through the above operations, the carbon nanotubes were formed on both the first carbon nanotube forming surface 11 and the second carbon nanotube forming surface 12 of the object 1. FIG. 5 depicts the formed carbon nanotubes. Since the reaction gases were introduced at substantially the same flow rate per unit time, the first carbon nanotubes 101 were approximately 94 μm long while the second carbon nanotubes 102 were approximately 94 μm.

### Example 2

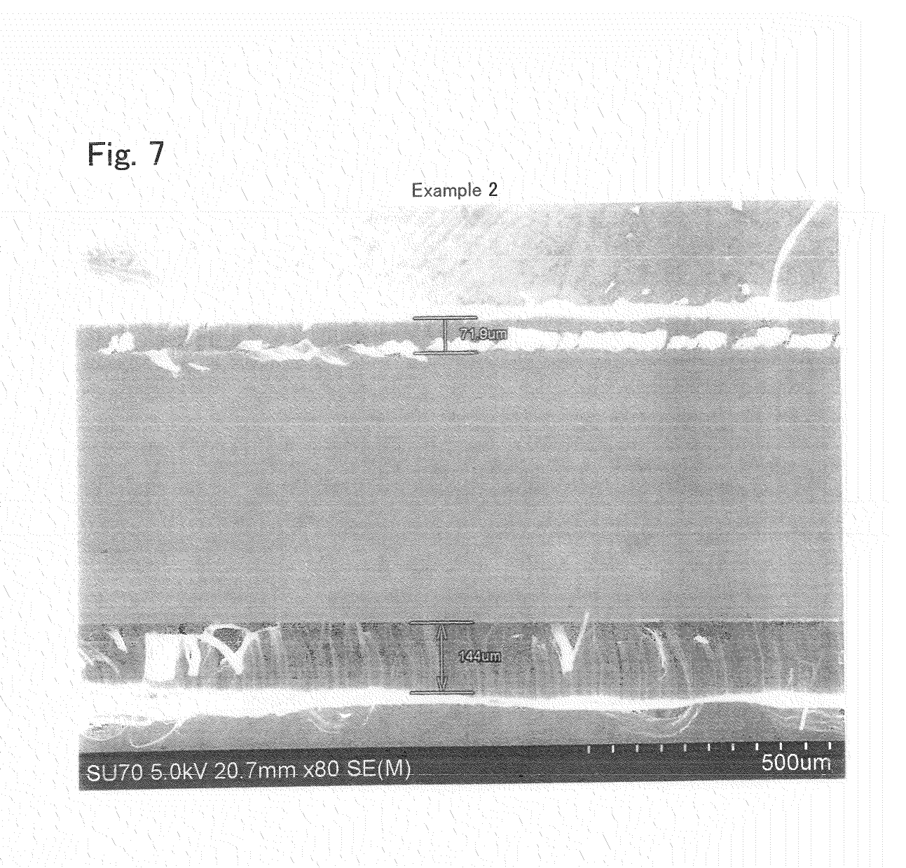

(Object 1) In Example 3, the first carbon nanotubes 101 formed on the first carbon nanotube forming surface 11 of the object 1 was made different from the second carbon nanotubes 102 formed on the second carbon nanotube forming surface 12 in terms of the length (see, FIG. 7). The object 1 was 0.5-millimeter thick silicon substrate. In respect of the upper-positioned first carbon nanotube forming surface 11, the surface roughness was Ra5 nanometer. In respect of the lower-positioned second carbon nanotube forming surface 12, the surface roughness was Ra100 nanometer, so that the second carbon nanotube forming surface 12 exhibited more surface roughness than the first carbon nanotube forming surface 11.

(Preliminary Processing) The same processing as in Example 1 was employed.

(CNT Formation) The same formation as in Comparative Example 1 was employed. The carbon nanotubes were formed on both the first carbon nanotube forming surface 11 and the second carbon nanotube forming surface 12 of the object 1. FIG. 7 depicts the formed carbon nanotubes in Example 2. As to the length of carbon nanotubes, the first carbon nanotubes 101 formed on the upper-positioned first carbon nanotube forming surface 11 were approximately 72 μm. The second carbon nanotubes 102 formed on the lower-positioned second carbon nanotube forming surface 12 were approximately 144 μm, which was approximately double of the length of the first carbon nanotubes 101.

### Example 1B

In this Example, carbon nanotube having different crystallinity are formed respectively on the first carbon nanotube forming surface and the second carbon nanotube forming surface of the object.

(Object 1) The object 1 is a 0.5-mm thick silicon substrate. Both surfaces of the substrate are polished, and the surface roughness is Ra5 nanometer.

(Preliminary Processing) As the first step, the surfaces of the object 1 undergo a water repellent processing. The processing agent is an agent in which 5 vol % of hexaorganosilazane is blended in toluene, and the object 1 is dipped in the processing agent for 30 minutes. After that, the object 1 is taken out and dried naturally. As the second step, both the first carbon nanotube forming surface 11 and the second carbon nanotube forming surface 12 of the object 1 are provided with 30-nanometer thin films of Fe—Ti alloy by dip coating method. The coating agent is prepared by dispersing Fe—Ti alloy particles (Fe:80%, Ti:20%) in hexane, and adjusting the concentration so that the absorbance becomes 0.3 when measured with a visible spectrophotometer (manufactured by WPA Corporation, C07500) under the measurement conditions of wavelength of 680 nanometers. In the dip coating method, dipping is conducted at normal temperature in the atmosphere. Then, the object 1 is pulled out at a speed of 3 mm/min. After the object is pulled out, hexane is shortly evaporated through natural drying.

(CNT Formation) With use of the above heat CVD device structured as depicted in FIGS. 1 to 4, the carbon nanotubes are formed. At this time, in the reaction container having been preliminarily vacuumed to 10 Pa, nitrogen gas serving as the carrier gas is introduced from both surfaces of the object 1 at 5000 cc/minute, and the pressure in the reaction container is adjusted to 1×10⁵ Pa. The heater temperature of the heater located closer to a first surface of the object 1 is set to a lower temperature (600° C.). The heater temperature of the heater located closer to a second surface of the object 1 is set to a higher temperature (750° C.). After the temperature has risen, as the source gas serving as the carbon source, acethylene gas is introduced at 1000 cc/minute from both surfaces of the object 1 for 6 minutes, and the carbon nanotubes are formed. The carbon nanotubes formed on the surface of the object 1 having the lower temperature exhibit low crystallinity due to the adhesion of amorphous carbons. On the other hand, the carbon nanotubes formed on the surface of the object 1 having the higher temperature exhibit high crystallinity. In the above formation, the carbon nanotubes having the lower crystallinity have more lost portions (i.e., the portions without carbon atoms that should have existed originally there) in graphene sheets. Therefore, the carbon nanotubes typically exhibit good supportability. By supporting lithium titanate particles, the carbon nanotubes will easily function as a negative electrode.

In contract, in the carbon nanotubes having higher crystallinity, good graphene sheets are formed. Thus, the carbon nanotubes are usable as a positive electrode which exhibits relatively high conductivity and durability. As depicted in FIGS. 15A and 15B, by layering the higher-crystalline carbon nanotubes and the lower-crystalline carbon nanotubes such that these carbon nanotubes are opposed to each other, and by connecting these carbon nanotubes in series, capacitors having a greater electromotive force are manufacturable at high productivity. The characteristics of the carbon nanotubes are controllable not only by the temperature at the time of forming the carbon nanotubes but also by the gas flow rate and the like for forming the carbon nanotubes.

### Example 2B

In this Example, carbon nanotube having different crystallinity are formed respectively on the first carbon nanotube forming surface 11 and the second carbon nanotube forming surface 12 of the object by changing the surface temperature of the object.

The object, the preliminary processing and the CNT formation are all the same as in Example 1B. Carbon nanotubes having lower crystallinity typically have a greater surface area. In contrast, carbon nanotubes having higher crystallinity exhibit relatively good conductivity. Accordingly, by layering the carbon nanotubes having lower crystallinity and the carbon nanotubes having higher crystallinity so that the former carbon nanotubes are opposed to each other while the latter carbon nanotubes are opposed to each other, and by connecting the former and latter carbon nanotubes in juxtaposition, the high output function and the high capacity function are exerted in a hybrid manner.

### Example 3B

In this Example, carbon nanotube having different thicknesses are formed respectively on the first carbon nanotube forming surface 11 and the second carbon nanotube forming surface 12 of the object 1.

(Object 1) The object 1 is a 0.5-mm thick silicon substrate. Both surfaces of the substrate are polished, and the surface roughness is Ra5 nanometer.

(Preliminary Processing) As the first step, the surfaces of the substrate undergo a water repellent processing. The processing agent is an agent in which 5 vol % of hexaorganosilazane is blended in toluene. The substrate is dipped in the processing agent for 30 minutes, and then taken out therefrom and dried naturally. As the second step, approximately 10-nanometer Fe thin films are formed on the first carbon nanotube forming surface 11 by spin coating method. The coating agent is prepared by dispersing Fe particles (Fe:100%) in hexane, and adjusting the concentration so that the absorbance becomes 0.3 when measured with a visible spectrophotometer (manufactured by WPA Corporation, CO7500) under the measurement conditions of wavelength of 680 nanometers. The spin coating is performed by making a rotation at approximately 5000 rpm for approximately 30 seconds in the atmosphere. After the rotation, hexane is shortly evaporated through natural drying. As the third step, onto the second carbon nanotube forming surface 12 (surface opposite to the first carbon nanotube forming surface 11 of the substrate) of the substrate, a 10-nanometer Fe—Ti thin film is formed by spin coating method. The coating agent forms an approximately 30-nanometer Fe—Ti alloy thin film in hexane. The coating agent is prepared by dispersing Fe-Ti alloy particles (Fe:80%, Ti:20%) in hexane, and adjusting the concentration so that the absorbance becomes 0.3 when measured with a visible spectrophotometer (manufactured by WPA Corporation, C07500) under the measurement conditions of wave length of 680 nanometers. The spin coating is performed by making a rotation at approximately 5000 rpm for approximately 30 seconds in the atmosphere. After the rotation, hexane is shortly evaporated through natural drying.

(CNT Formation) With use of the above heat CVD device structured as depicted in FIGS. 1 to 4, the carbon nanotubes are formed. At this time, in the reaction container having been preliminarily vacuumed to 10 Pa, nitrogen gas serving as the carrier gas is introduced from both surfaces of the substrate at 5000 cc/minute, and the pressure in the reaction container is adjusted to 1×10⁵ Pa. After the surface temperature of the substrate has been raised to 600° C., as the source gas serving as the carbon source, acethylene gas is introduced at 1000 cc/minute from both surfaces of the substrate for 6 minutes, and the carbon nanotubes are formed.

The diameter of the carbon nanotubes formed on the surface provided with a Fe catalyst is as great as 15 nanometers. In contrast, the diameter of the carbon nanotubes formed on the surface provided with Fe—Ti catalyst is as small as 8 nanometers. As depicted in FIG. 17, the thick carbon nanotubes having a great diameter typically exhibit good supportability, and thus easily serve as a negative electrode by supporting lithium titanate particles. In contrast, the thin carbon nanotubes having a small diameter are relatively favorable in impregnation of electrolyte, and thus usable as a positive electrode excellent in ion conductivity. By layering the thicker carbon nanotubes and the thinner carbon nanotubes such that the thicker carbon nanotubes are opposed to the thinner carbon nanotubes, and by connecting the thicker and thinner carbon nanotubes in series, capacitors having a greater electromotive force are manufacturable at high productivity.

### Example 4B

According to this Example, the carbon nanotubes formed on the first carbon nanotube forming surface 11 of the object 1 are different from the carbon nanotubes formed on the second carbon nanotube forming surface 12 of the object 1, in terms of the tube number of the carbon nanotubes per unit area.

(Substrate) The object 1 is 0.5-millimeter thick silicon substrate. Both surfaces of the substrate are polished and the surface roughness is Ra5 nanometer.

(Preliminary Processing) As the first step, the surfaces of the substrate undergo a water repellent processing. The processing agent is an agent in which 5 volume % of hexaorganosilazane is blended in toluene. After the substrate is dipped in the processing agent for 30 minutes, the substrate is taken out from the agent and dried naturally. As the second step, a 30-nanometer Fe—Ti alloy thin film is formed on both surfaces of the silicon substrate by dip coating method. The coating agent is prepared by dispersing Fe—Ti alloy particles (Fe:80%, Ti:20%) in hexane, and adjusting the concentration so that the absorbance became 0.3 when measured with a visible spectrophotometer (manufactured by WPA Corporation, C07500) under the measurement conditions of wavelength of 680 nanometers. In the dip coating method, dipping is conducted at normal temperature in the atmosphere, and the substrate is pulled out at a speed of 3 mm/min. After the substrate is pulled out, hexane is shortly evaporated through natural drying.

(CNT Formation) With use of the heat CVD device structured as depicted in FIGS. 1 to 4 and having the fewer number of the outlets 41 and 42 for letting out the reaction gas onto the object 1 (or having the outlets 41 and 42 whose opening diameters are reduced), the carbon nanotubes are formed. In the reaction container having been preliminarily vacuumed to 10 Pa, nitrogen gas serving as the carrier gas is introduced from both surfaces of the substrate at 5000 cc/minute, and the pressure in the reaction container is adjusted to 1×10⁵ Pa. After the surface temperature of the substrate has been raised to 600° C., as the source gas serving as the carbon source, acethylene gas is introduced at 1000 cc/minute from both surfaces of the substrate for 6 minutes, and the carbon nanotubes are formed. In the surface having the fewer number of the outlets 41 and 42, the source gas less frequently reaches the catalyst, which results in the fewer number of the carbon nanotubes per unit area. The surface where the more number of the carbon nanotubes per unit area are formed typically exhibits good supportability (because more supporting scaffolds are provided), and easily serve as a negative electrode by supporting particles such as lithium titanate particles.

In contrast, the carbon nanotube whose tube number per unit area is smaller secures clearances between the adjoining carbon nanotubes. Thus, the carbon nanotubes are favorable in impregnation of electrolyte, and usable as a positive electrode excellent in ion conductivity. By layering the carbon nanotubes whose tube number per unit area is greater and the carbon nanotubes whose tube number per unit area is smaller such that the former carbon nanotubes are opposed to the latter carbon nanotubes, and by connecting the former and latter carbon nanotubes in series, capacitors having a greater electromotive force are manufacturable at high productivity. By changing not only the temperatures but also the surface roughness of the substrate, the diameter of the catalyst, the activity of the catalyst, the flow rate of the gas and the like, the formation of the carbon nanotubes are controllable.

(Others) The above Example is an example in which the first carbon nanotubes and the second carbon nanotubes are different from each other in terms of a single factor (any one of the length, crystallinity and the tube number). However, in respect of the carbon nanotubes, a plurality of factors selected from length, diameter, tube number per unit area, number of layers, crystallinity, lost portion amount, functional group type, functional group amount, density, weight, distribution and others may be made different.

### Manufacturing Embodiment 3

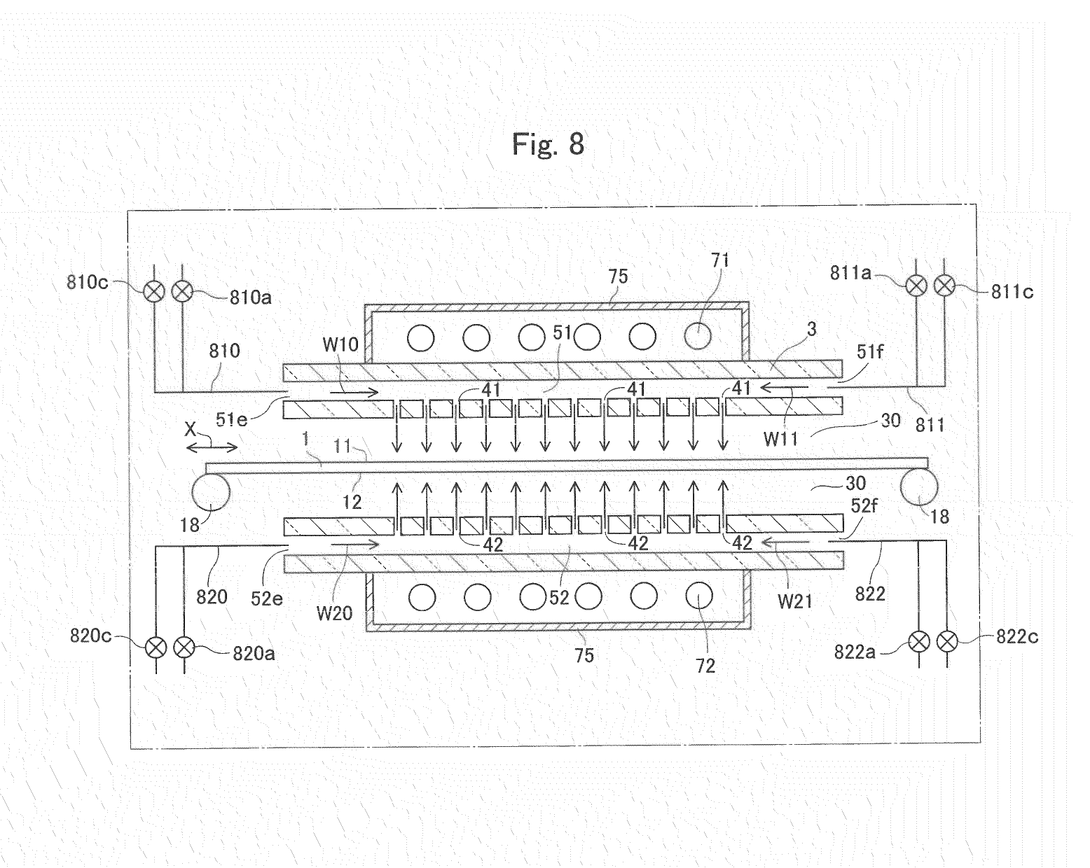

FIG. 8 depicts a manufacturing embodiment 3. This manufacturing embodiment basically includes the same arrangements as in the manufacturing embodiments 1 and 2, and provides the same effects and advantages as the manufacturing embodiments 1 and 2. In the following description, the difference of this manufacturing embodiment from the manufacturing embodiment 1 or 2 will be mainly described. As depicted in FIG. 8, a first end 51e of a first gas feeding chamber 51 is provided with a feeding path 810, a feeding valve 810a for a first reaction gas and a feeding valve 810c for a carrier gas. As depicted in FIG. 8, a second end 51f of a first gas feeding chamber 51 is provided with a feeding path 811, a feeding valve 811a for the first reaction gas and a feeding valve 811c for the carrier gas. When the first reaction gas is fed into the first gas feeding chamber 51, the flow rate per unit time of the gas is controllable at the first end 51e and the second end 51f of the first gas feeding chamber 51. According to this arrangement, in the first carbon nanotube forming surface 11, the property of the first carbon nanotubes 11 (at least one of length, diameter, tube number per unit area, number of layers, crystallinity, lost portion amount, functional group type, functional group amount, density, weight, distribution and others) are expected to be made different depending on whether the first carbon nanotubes 11 are closer to the first end 51e or to the second end 51f.

As depicted in FIG. 8, a first end 52e of a second gas feeding chamber 52 is provided with a feeding path 820, a feeding valve 820a for a second reaction gas and a feeding valve 820c for a carrier gas. A second end 52f of the second feeding chamber 52 is provided with a feeding path 822, a feeding valve 822a for the second reaction gas and a feeding valve 822c for the carrier gas. When the second reaction gas is fed into the second gas feeding chamber 52, the flow rate per unit time of the gas is controllable at the first end 52e and the second end 52f of the second gas feeding chamber 52. According to this arrangement, in the second carbon nanotube forming surface 12, the characteristics of the second carbon nanotubes 12 are expected to be made different depending on whether the second carbon nanotubes 12 are closer to the first end 52e or to the second end 52f.

### Manufacturing Embodiment 4

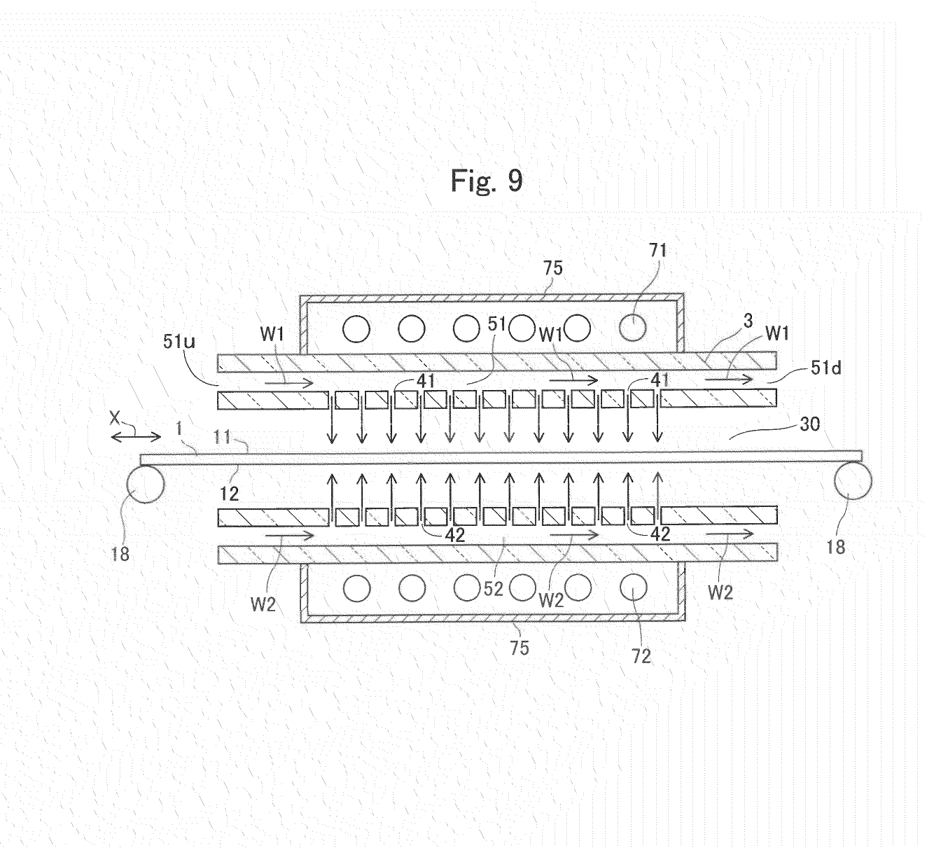

FIG. 9 depicts a manufacturing embodiment 4. This manufacturing embodiment basically includes the same arrangements as in the manufacturing embodiments 1 to 3, and provides the same effects and advantages as the manufacturing embodiments 1 to 3. In the following description, the difference of this manufacturing embodiment from the manufacturing embodiments 1 to 3 will be mainly described. As depicted in FIG. 9, the first gas feeding chamber 51 and the second gas feeding chamber 52 extend in a transverse direction (horizontal direction). The first reaction gas is directed in a direction indicated by an arrow W1 (a single direction, and right direction in FIG. 9) to be fed to the first gas feeding chamber 51. The first reaction gas is let out downward from a plurality of first outlets 41 to substantially perpendicularly collide on the first carbon nanotube forming surface 11 of the object 1. The second reaction gas is directed in a direction indicated by an arrow W2 (a single direction, and right direction in FIG. 9) to be fed to the second gas feeding chamber 52. The second reaction gas is let out upward from a plurality of second outlets 42 to substantially perpendicularly collide on the second carbon nanotube forming surface 12 of the object 1.

In this arrangement, taking into account the first reaction gas fed into the reaction chamber 30 from the first gas feeding chamber 51 via the first outlets 41, when the first reaction gas flows in the direction indicated by the arrow W1 in FIG. 9 within the first gas feeding chamber 51, the flow rate of the first reaction gas is gradually decreased as the first reaction gas advances toward a downstream region 51d of the first gas feeding chamber 51 from an upstream region 51u of the first gas feeding chamber 51. Accordingly, when the number of the first outlets 41 remains the same, inner diameters of the first outlets 41 become relatively greater in the downstream region 51d of the first gas feeding chamber 51 than in the upstream region 51u of the first gas feeding chamber 51. Alternatively, when the inner diameters of the first outlets 41 remain the same, the number of the first outlets 41 per unit area is greater in the downstream region 51d of the first gas feeding chamber 51 than in the upstream region 51u of the first gas feeding chamber 51. A reason therefor is to reduce the irregularities of the injecting flow rate of the first reaction gas when the first reaction gas is injected from the first gas feeding chamber 51 into the reaction chamber 30. This manufacturing embodiment described above is advantageous in reducing the irregularities of the whole first carbon nanotubes 101 formed on the first carbon nanotube forming surface 11.

The same is true of the second outlets 42. Specifically, when the second reaction gas flows in a direction indicated by an arrow W2 in FIG. 9 within the second gas feeding chamber 52, the flow rate of the second reaction gas is gradually decreased as the second reaction gas advances toward a downstream region 52d of the second gas feeding chamber 52 from an upstream region 52u of the second gas feeding chamber 52. Accordingly, when the number of the second outlets 42 remains the same, inner diameters of the second outlets 42 become relatively greater in the downstream region 52d of the second gas feeding chamber 52 than in the upstream region 52u of the second gas feeding chamber 52. Alternatively, when the inner diameters of the second outlets 42 remain the same, the number of the second outlets 42 per unit area is relatively greater in the downstream region 52d of the second gas feeding chamber 52 than in the upstream region 52u of the second gas feeding chamber 52. A reason therefor is to reduce the irregularities of the injecting flow rate of the second reaction gas when the second reaction gas is injected from the second gas feeding chamber 52 into the reaction chamber 30. This manufacturing embodiment described above is advantageous in reducing the irregularities of the whole second carbon nanotubes 102 formed on the second carbon nanotube forming surface 12.

### Manufacturing Embodiment 5

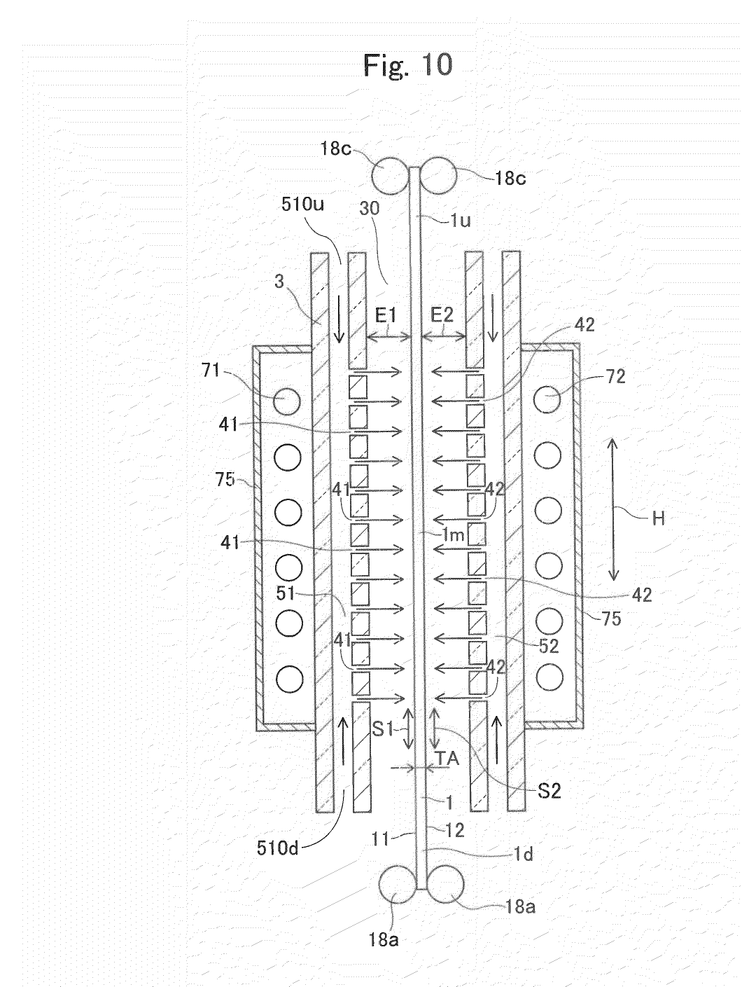

FIG. 10 depicts a manufacturing embodiment 5. This manufacturing embodiment basically includes the same arrangements as in the manufacturing embodiments 1 to 4, and provides the same effects and advantages as the manufacturing embodiments 1 to 4. In the following description, the difference of this manufacturing embodiment from the manufacturing embodiments 1 to 4 will be mainly described. As depicted in FIG. 10, while a first gas feeding chamber 51 and a second gas feeding chamber 52 are box-shaped paths opposed to each other, the first gas feeding chamber 51 and the second gas feeding chamber 52 extend in a vertical direction (height direction, direction indicated by an arrow H). An object 1 is aligned in the vertical direction, and has an upper portion 1u and a lower portion 1d. Carbon nanotube forming surfaces 11 and 12 extend in the height direction (the direction indicated by the arrow H). A first reaction, gas fed in the first gas feeding chamber 51 is transversely injected through the first outlets 41 to collide onto the first carbon nanotube forming surface 11 of the object 1 substantially at an angle of 85 to 90′, preferably at 90°. A second reaction gas fed in the second gas feeding chamber 52 is transversely injected through the second outlets 42 to collide onto the second carbon nanotube forming surface 12 of the object 1 substantially at an angle of 85 to 95°, preferably at 90°.

According to this manufacturing embodiment, even when the distance between an upper installation portion 18c and a lower installation portion 18a is great, or even when the thickness TA of the object 1 is small, or even when the rigidity of the object 1 is low, a portion 1m of the object 1 extending between the installation portions 18a and 18c is restricted from drooping downward due to gravity. Further, a first end of the object 1 is sandwiched between the installation portions 18c and 18c while a second end of the object 1 is sandwiched between the installation portions 18a and 18a. Then, the installation portions 18c and 18c and the installation portions 18a and 18a are displaced respectively in planar directions S1 and S2 of the object 1 so as to be relatively spaced apart from each other. With this arrangement, the object 1 is given a tension in the planar directions S1 and S2, thereby restricting the deflection deformation of the portion 1m of the object 1. In this arrangement, clearances E1 and E2 are kept at targeted values. By equalizing the flow rate per unit time of the first reaction gas let out from the first outlets 41 to the flow rate per unit time of the second reaction gas let out from the second outlets 42, the application of differential pressures onto the carbon nanotube forming surfaces 11 and 12 of the object 1 will be restricted. Resultantly, the portion 1m of the object 1 is restricted from being displaced in the thickness direction of the object 1 due to the differential pressures. This arrangement contributes to stabilization of the characteristics of the carbon nanotubes 101. Likewise, this arrangement contributes to stabilization of the characteristics of the second carbon nanotubes 102.

### Manufacturing Embodiment 6

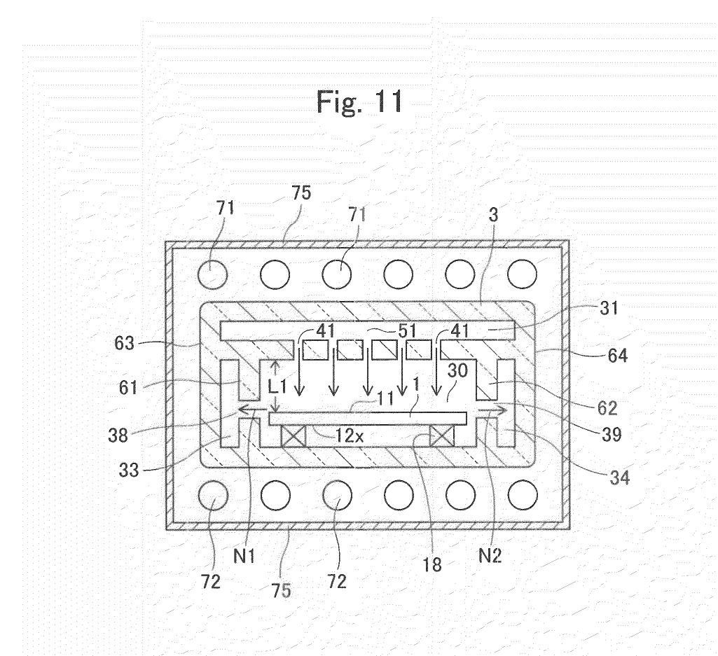

FIG. 11 depicts a manufacturing embodiment 6. This manufacturing embodiment basically includes the same arrangements as in the manufacturing embodiments 1 to 5, and provides the same effects and advantages as the manufacturing embodiments 1 to 5. As depicted in FIG. 11, a first facing wall 31 and a first gas feeding chamber 51 two-dimensionally and transversely extend in a planar direction of a first carbon nanotube forming surface 11 of a plate-shaped object 1. The first gas feeding chamber 51, which is defined by the transversely-extending first facing wall 31, two-dimensionally and transversely extends in the planar direction of the first carbon nanotube forming surface 11 of the plate-shaped object 1. The first gas feeding chamber 51 as described above is a box-shaped flat path opposed to the first carbon nanotube forming surface 11. First outlets 41 are formed in a dispersed manner in substantially the entirety of the first facing wall 31 substantially at equal intervals. The first reaction gas fed in the first gas feeding chamber 51 is injected downward through the first outlets 41 to substantially perpendicularly collide onto the first carbon nanotube forming surface 11 of the object 1. Since no second gas feeding chamber 52 is provided, in the object 1, the carbon nanotubes are mainly formed on the first carbon nanotube forming surface 11.

Specifically, by feeding the reaction gas into the first gas feeding chamber 51, the reaction gas in the first gas feeding chamber 51 is injected through the first outlets 41 in a direction that intersects with the planar direction in which the first carbon nanotube forming surface 11 of the object 1 within the reaction chamber 30 extends (i.e., a direction substantially perpendicular to the first carbon nanotube forming surface 11) to collide onto the first carbon nanotube forming surface 11 of the object 1. With this arrangement, the carbon nanotubes are formed on the first carbon nanotube forming surface 11 of the object 1.

Also according to this manufacturing embodiment, when the shortest distance L1 between each first outlet 41 and the same first carbon nanotube forming surface 11 of the object 1 is relatively indicated as 100, the distance between the first outlet and the same carbon nanotube forming surface at the time of letting out the reaction gas is set within a range of 90 to 110 entirely along the first outlets 41 (particularly in the range of 95 to 105, specifically 100). Thus, with respect to the first outlets 41 each, the shortest distances L from the first outlets 41 to the first carbon nanotube forming surface 11 of the object 1 are uniformed. Therefore, this arrangement contributes to the reduction in the irregularities of the whole first carbon nanotubes 101 formed on the first carbon nanotube forming surface 11. As understood from FIG. 11, a surface 12x of the object 1 opposite to the first carbon nanotube forming surface 11 is not directly applied with the reaction gas. While the carbon nanotubes are formed on the surface 12x, the characteristics of the carbon nanotubes on the surface 12x are made different due to the limitation in the feeding of the reaction gas to the surface 12x.

### Manufacturing Embodiment 7

FIG. 12 depicts a manufacturing embodiment 7. This manufacturing embodiment basically includes the same arrangements as in the manufacturing embodiments 1 to 6, and provides the same effects and advantages as the manufacturing embodiments 1 to 6. As depicted in FIG. 12, at the time of letting out the first reaction gas, the distance between each first outlet 41 and the same first carbon nanotube forming surface 11 of an object 1 is made the shortest (the shortest distance L1). When the shortest distance L1 is relatively indicated as 100, the distance between the first outlet 41 and the same first carbon nanotube forming surface 11 is set within a range of 90 to 110 entirely along the first outlets 41 (particularly in the range of 95 to 105, specifically 100). Thus, the shortest distances L1 from the first outlets 41 to the first carbon nanotube forming surface 11 of the object 1 are uniformed. With this arrangement, the irregularities of the whole first carbon nanotubes 101 formed on the first carbon nanotube forming surface 11 are reduced.

Likewise, at the time of letting out a second reaction gas, the distance between each second outlet 42 and the same second carbon nanotube forming surface 12 of the object 1 is made the shortest (the shortest distance L2). When the shortest distance L2 is relatively indicated as 100, the distance between the second outlet 42 and the same second carbon nanotube forming surface 12 is preferably set within a range of 75 to 125 entirely along the second outlets 42. Specifically, in respect of each second outlet 42, the shortest distance is set within the range of 90 to 110 (in particular, within the range of 95 to 105). Thus, the shortest distances L2 from the second outlets 42 to the second carbon nanotube forming surface 12 of the object 1 are uniformed. With this arrangement, the irregularities of the whole second carbon nanotubes 102 formed on the second carbon nanotube forming surface 12 are reduced.

According to this manufacturing embodiment, as depicted in FIG. 12, the shortest distance L1 is smaller than the shortest distance L2. Accordingly, the clearance E1 is also smaller than the clearance E2. This arrangement contributes to making the first carbon nanotubes 101 formed on the first carbon nanotube forming surface 11 different from the second carbon nanotubes 102 formed on the second carbon nanotube forming surface 12 in terms of the characteristics. Alternatively, the shortest distance L1 may be greater than the shortest distance L2.

(Others) This invention is not limited to the manufacturing embodiments described above and depicted in the drawings, but may be suitably altered to the extent not to exceed the gist thereof in its implementation. According to the description made herein, the following technical ideas are conceivable. The greater the size of the catalyst particles becomes, the greater the layer number in the multilayer carbon nanotubes becomes. Although depending on the size of the catalyst particles supported on the surfaces of the substrate, the multilayer carbon nanotubes may be made carbon nanotubes including 10 layers or more, 20 layers or more, 30 layers or more, 40 layers or more and 50 layers or more. Accordingly, by changing the size of the catalyst particles supported in the first carbon nanotube forming surface 11 and the second carbon nanotube forming surface 12, the layer numbers in the first carbon nanotubes 101 and the second carbon nanotubes 102 are changeable.

1. A carbon nanotube device, comprising a carbon nanotube element comprising an object having a first carbon nanotube forming surface and a second carbon nanotube forming surface,
wherein:
first carbon nanotubes are formed on the first carbon nanotube forming surface of the object, and second carbon nanotubes formed on the second carbon nanotube forming surface of the object; and
properties of the second carbon nanotubes and the first carbon nanotubes are different.

2. The carbon nanotube device according to claim 1, wherein the property is at least one of length, diameter, tube number per unit area, number of layers, crystallinity, lost portion amount, functional group type, functional group amount, density, weight, and distribution.

3. The carbon nanotube device according to claim 1, wherein a plurality of the carbon nanotube elements are arranged side by side in such a manner that first carbon nanotubes of one of the carbon nanotube elements are situated opposite to first carbon nanotubes of another of the carbon nanotube elements that is adjoining the one of the carbon nanotube elements, and the second carbon nanotubes of the one of the carbon nanotube elements are situated opposite to the second carbon nanotubes of another of the carbon nanotube elements that adjoining to the one of the carbon nanotube elements.

4. The carbon nanotube device according to claim 1, wherein a plurality of carbon nanotube elements are arranged side by side in such a manner that first carbon nanotubes of one of the carbon nanotube elements are in opposition to second carbon nanotubes of another of the carbon nanotube elements that is adjoining the one of the carbon nanotube elements.

5. A method of manufacturing carbon nanotubes, the method comprising:
heating at least one of a carbon nanotube forming surface of a target object, a gas path forming member, and a reaction gas to a carbon nanotube forming temperature; and
feeding the reaction gas into a gas feeding chamber and releasing the reaction gas in the gas feeding chamber through a plurality of outlets onto the carbon nanotube forming surface of the target object, such that carbon nanotubes are formed on the carbon nanotube forming surface of the target object, and the reaction gas is released out in a direction that intersects with a planar direction in which the carbon nanotube forming surface of the target object within the reaction chamber extends, wherein:
the target object comprises the carbon nanotube forming surface on which the carbon nanotubes are formed;
the gas path forming member comprises:
a reaction chamber adapted to accommodate the target object;
the gas feeding chamber which faces the carbon nanotube forming surface of the target object in the reaction chamber with a clearance interposed, such that the gas feeding chamber extends in a planar direction in which the carbon nanotube forming surface extends; and
the plurality of outlets connected with the gas feeding chamber and the reaction chamber and adapted to release the reaction gas in the gas feeding chamber into the reaction chamber;
a heat source is adapted to heat to the carbon nanotube forming temperature at least one of the carbon nanotube forming surface of the target object, the gas path forming member, and the reaction gas;
the carbon nanotube forming surface of the target object comprises a first carbon nanotube forming surface and a second carbon nanotube forming surface; and
a first operation through which the carbon nanotubes are formed on the first carbon nanotube forming surface and a second operation through which the carbon nanotubes are formed on the second carbon nanotube forming surface are independently controlled.

6. The method according to claim 5, wherein, when a shortest distance L between the plurality of outlets and the carbon nanotube forming surface of the target object is relatively as 100, the shortest distance L when the reaction gas is released is set within a range of 75 to 125 entirely along the plurality of outlets, such that the shortest distance L between the outlets each and the carbon nanotube forming surf ace of the target object is uniformed in respect of the plurality of outlets.

7. (canceled)

8. A carbon nanotube manufacturing apparatus comprising:
(i) a base body;
(ii) a gas path forming member comprising:
a facing wall attached to the base body and adapted to face a carbon nanotube forming surface of a target object with a clearance interposed, such that the facing wall extends in a planar direction in which the carbon nanotube forming surface of the target object extends;
a plurality of outlets formed in the facing wall to penetrate through the facing wall;
a gas feeding chamber defined by the facing wall and extending in the planar direction in which the carbon nanotube forming surface of the target object extends, such that the gas feeding chamber connects with the plurality of outlets; and
a gas outlet path connecting with a reaction chamber; and
(iii) a heat source connected to the base body and adapted to heat to a carbon nanotube forming temperature at least one of the carbon nanotube forming surface of the target object, the gas path forming member and reaction gas,
wherein:
the carbon nanotube forming surface of the target object comprises a first carbon nanotube forming surface and a second carbon nanotube forming surface positioned respectively at different positions;
the facing wall comprises:
a first facing wall facing the first carbon nanotube forming surface of the target object with a first clearance interposed; and
a second facing wall facing the second carbon nanotube forming surface of the target object with a second clearance interposed;
the plurality of outlets include first outlets formed in the first facing wall and second outlets formed in the second facing wall;
the gas feeding chamber comprises:
a first gas feeding chamber connected to a first gas feeding path and connected with the first outlets; and
a second gas feeding chamber connected to a second gas feeding path and connected with the second outlets;
the heat source comprises includes:
a first heat source adapted to heat to a first carbon nanotube forming temperature at least one of a first reaction gas for forming the carbon nanotubes on the first carbon nanotube forming surface, the first carbon nanotube forming surface of the target object, and the first gas feeding chamber; and
a second heat source adapted to heat to a second carbon nanotube forming temperature at least one of a second reaction gas for forming the carbon nanotube on the second carbon nanotube forming surfaces, the second carbon nanotube forming surface of the target object, and the second gas feeding chamber; and
the apparatus is adapted to manufacture carbon nanotubes on a target object comprising the carbon nanotube forming surface on which the carbon nanotubes are formed.

9. The carbon nanotube manufacturing apparatus according to claim 8, wherein an extension that extends from a center line of each outlet toward the target object is set to intersect with the planar direction in which the carbon nanotube forming surface of the target object extends, at an angle within a predetermined angle 0 (0=70 to 110°).

10. (canceled)

11. The carbon nanotube manufacturing apparatus according to claim 8, wherein an exit of the reaction chamber of the gas path forming member is positioned at a position facing a lateral end surface of the target object.

12. The carbon nanotube device according to claim 2, wherein a plurality of the carbon nanotube elements are arranged side by side in such a manner that first carbon nanotubes of one of the carbon nanotube elements are situated opposite to first carbon nanotubes of another of the carbon nanotube elements that is adjoining the one of the carbon nanotube elements, and the second carbon nanotubes of the one of the carbon nanotube elements are situated opposite to the second carbon nanotubes of another of the carbon nanotube elements that adjoining to the one of the carbon nanotube elements.

13. The carbon nanotube device according to claim 2, wherein a plurality of carbon nanotube elements are arranged side by side in such a manner that first carbon nanotubes of one of the carbon nanotube elements are in opposition to second carbon nanotubes of another of the carbon nanotube elements that is adjoining the one of the carbon nanotube elements.

14. The carbon nanotube manufacturing apparatus according to claim 9, wherein an exit of the reaction chamber of the gas path forming member is positioned at a position facing a lateral end surface of the target object.
